(19) United States
(12) Patent Application Publication
(10) Pub. No.: US 2025/0185029 A1
(43) Pub. Date: Jun. 5, 2025

(54) Sidelink Communication using Shared Channel Occupancy in Unlicensed Spectrum

(71) Applicant: Telefonaktiebolaget LM Ericsson (publ), Stockholm (SE)

(72) Inventors: Majid Gerami, Lund (SE); Bikramjit Singh, Raasepori (FI); Min Wang, Luleå (SE)

(21) Appl. No.: 18/842,875

(22) PCT Filed: Apr. 11, 2022
(86) PCT No.: PCT/EP2022/059635

§ 371 Date: Aug. 30, 2024

(51) Int. Cl. H04W 72/25; H04L 27/26; H04W 16/14

(52) U.S. Cl. CPC H04W 72/25; H04L 27/2678; H04W 16/14

(57) ABSTRACT

Embodiments include methods for a first user equipment (UE) configured for sidelink (SL) communication with at least a second UE in a wireless network. Such methods include receiving, from a radio access network (RAN) node of the wireless network, a first message indicating that the first UE is permitted to initiate one or more channel occupancy time (COTs) for a channel in unlicensed spectrum and to share the one or more COTs with at least the second UE for SL communication. Such methods include initiating a first COT of the one or more COTs for the channel, as permitted by the first message; and receiving data from the second UE based on SL communication via the channel during the first COT. Other embodiments include complementary methods for a second UE and for a RAN node, as well as UEs and RAN nodes configured to perform such methods.

### TECHNICAL FIELD

Embodiments of the present disclosure generally relate to wireless communication networks, and particularly relates to improving device-to-device (D2D) communication between user equipment (UEs) operating in unlicensed spectrum.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with fourth-generation Long-Term Evolution (LTE). For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases (e.g., in higher frequency bands).

License Assisted Access (LAA) is an LTE feature that uses unlicensed 5-GHz spectrum in combination with licensed spectrum to deliver a performance boost for mobile device users. LAA uses DL carrier aggregation (CA) to combine LTE in licensed and unlicensed bands to provide better data rates and a better user experience. For example, in LAA, the UE's primary cell (PCell) is in a licensed band while the UE's secondary cells (SCells) can be in an unlicensed band. Since LAA operates in the 5-GHz band where Wi-Fi operates, it must be able to co-exist with Wi-Fi by avoiding channels occupied by Wi-Fi users. LAA uses a concept called Listen-before-talk (LBT) that dynamically selects 5-GHz-band channel(s) that is(are) not being used, i.e., a “clear channel.” If no clear channel is available, LAA will share a channel fairly with others. As such, LBT is often referred to as clear channel assessment (CCA).

NR Rel-16 includes a feature similar to LTE LAA, referred to as NR-Unlicensed (NR-U). In contrast to LTE LAA, NR-U supports dual-connectivity (DC) and standalone scenarios in which cooperative licensed spectrum is not available. In such scenarios, medium access control (MAC, e.g., random access) and scheduling procedures on unlicensed spectrum are subject to the LBT failures. This was not the case for LTE LAA, since MAC and scheduling procedures were performed in the licensed spectrum where LBT is unnecessary. Note the terms “shared” and “unlicensed” are used synonymously herein when referring to spectrum, unless stated otherwise.

Sidelink (SL) is a type of device-to-device (D2D) communication in which UEs communicate with each other directly rather than indirectly via a 3GPP RAN. D2D was first introduced in LTE Rel-12, targeting public safety use cases and proximity-based services (ProSe). Subsequently, various extensions have been introduced to broaden the range of use cases that can benefit from D2D technology. For example, D2D extensions in LTE Rel-14 and Rel-15 include supporting vehicle-to-everything (V2X) communication.

3GPP Rel-16 specifies the NR SL interface and targets advanced V2X services, including four primary groups of use cases: vehicles platooning, extended sensors, advanced driving, and remote driving. The advanced V2X services require a new SL in order to meet the stringent requirements in terms of latency and reliability. The NR SL is designed to provide higher system capacity and better coverage, and to allow for extension to support the future development of even more advanced V2X services and other related services.

Broadcast, groupcast, and unicast transmissions are desirable for the services targeted by NR SL. In groupcast (or multicast), the intended receiver of a message consists of only a subset of the possible recipients in proximity to the transmitter, whereas a unicast message is intended for only one recipient in proximity to the transmitter. For example, in the platooning service there are certain messages that are of interest only to platoon members, for which groupcast can be used. Unicast is a natural fit for use cases involving only a pair of vehicles.

Furthermore, NR SL is designed such that it is operable both with and without network coverage and with varying degrees of interaction between the UEs (user equipment) and the RAN, including support for standalone, network-less operation. For example, national security and public safety (NSPS) services often need to operate without (or with partial) RAN coverage, such as during indoor firefighting, forest firefighting, earthquake rescue, sea rescue, etc. Network coverage extension is a crucial enabler in these scenarios.

3GPP Rel-17 includes a study item for coverage extension for SL-based communication, including UE-to-network (U2N) relay for cellular coverage extension and UE-to-UE (U2U) relay for SL coverage extension. Other goas of the Rel-17 work include improve performance of power-limited UEs (e.g., pedestrian UEs, first responder UEs, etc.) and improved resource coordination.

### SUMMARY

It is expected that sixth-generation (6G) wireless systems and further enhancements to 5G systems will address high-data-traffic consumer use cases such as augmented reality (AR), virtual reality (VR), extended reality (XR), cloud gaming, etc. Moreover, it is expected that 6G and/or enhanced 5G will address many of these use cases based on D2D communication since it can provide higher data rates, lower latency, improved reliability, reduced energy consumption, etc.

Furthermore, it is expected that 6G and/or enhanced 5G will use higher-frequency spectrum such as 100-300 GHz and beyond, which is generally referred to as “millimeter wave” (or mmW for short). UE-to-UE and UE-to-network transmissions have higher path loss in mmW spectrum compared to lower frequencies, and typically must be carried over narrow, high-gain beams. Additionally, it is expected that most mmW bands will operate as shared or unlicensed spectrum (also referred to as licensed-exempt spectrum).

Currently, however, NR-U channel access rules are specified for UL and DL communication between UE and network (i.e., Uu interface) but not for SL communication between UEs. This can cause various problems, issues, and/or difficulties, particularly for sharing a channel occupancy time (COT) obtained by a first UE (e.g., via CCA) with a second UE engaged in SL D2D communication with the first UE.

Embodiments of the present disclosure provide specific improvements to D2D communication between UEs in unlicensed or shared spectrum, such as by providing, enabling, and/or facilitating solutions to overcome exemplary problems summarized above and described in more detail below.

Embodiments include exemplary methods (e.g., procedures) for a first UE configured for SL communication with at least a second UE in a wireless network. These exemplary methods can include receiving, from a RAN node of the wireless network, a first message indicating that the first UE is permitted to initiate one or more COTs for a channel in unlicensed spectrum and to share the one or more COTs with at least the second UE for SL communication. These exemplary methods can also include initiating a first COT of the one or more COTs for the channel, as permitted by the first message. These exemplary methods can also include receiving data from the second UE based on SL communication via the channel during the first COT.

In some embodiments, these exemplary methods can also include receiving, from the RAN node, an allocation of resources for SL communication with at least the second UE during the one or more COTs that include the first COT. In some embodiments, these exemplary methods can also include sending, to the RAN node, a request to initiate the first COT for the channel and to share the first COT with at least the second UE for SL communication. The first message can be received in response to the request.

In some embodiments, the allocation of resources is for the first COT and the allocation is received in response to sending the request. In other embodiments, the allocation of resources is for a plurality of COTs including the first COT.

In various embodiments, the request can include one or more of the following:
start time, end time, and/or maximum duration of the first COT;
durations within the first COT that are reserved for other UEs to transmit;
an identifier of the first UE;
a UE identifier or a group identifier associated with the second UE;
SL transmission types allowed during the first COT;
one or more services, logical channels (LCHs), logical channel groups (LCGs), or channel access priority classes allowed during the first COT;
one or more types of signaling and/or data transmissions allowed during the first COT;
one or more listen-before-talk (LBT) categories required or allowed during the first COT;
cyclic prefix (CP) configuration to be used by the second UE during the first COT; and
types of SL grants allowed during the first COT.

In various embodiments, the request can be sent according to one or more of the following:
in a radio resource control (RRC) message;
in a medium access control (MAC) control element (CE);
in a message during a random access (RA) procedure initiated by the first UE;
in a control protocol data unit (PDU) for a user-plane protocol;
via a physical uplink control channel (PUCCH); and
via a physical uplink shared channel (PUSCH).

In various embodiments, the first message can include one or more of the following:
respective start times, end times, and/or maximum durations of the one or more COTs;
durations within the one or more COTs that are reserved for other UEs to transmit;
maximum number of UEs allowed to share the one or more COTs;
at least one identifier of a UE allowed to share the one or more COTs;
at least one group identifier associated with UEs allowed to share the one or more COTs;
SL transmission types allowed during the one or more COTs;
one or more services, LCHs, LCGs, or channel access priority classes allowed during the one or more COTs;
one or more types of signaling and/or data transmissions allowed during the one or more COTs;
one or more types of channel occupancy allowed during the one or more COTs;
whether the first UE, the RAN node, or both are allowed to initiate the one or more COTs;
and
one or more LBT categories required or allowed during the one or more COTs;
CP configuration to be used by UEs allowed to share the one or more COTs; and
types of SL grants allowed during the one or more COTs.

In some embodiments, the first message is received as downlink control information (DCI) via PDCCH and the DCI includes a bitfield that can take on a plurality of values. Each bitfield value is associated with values or settings for at least two the following:
whether dynamic channel occupancy, semi-static channel occupancy, or both are allowed during the one or more COTs;
whether the first UE, the RAN node, or both are allowed to initiate the one or more COTs; and
CP configuration to be used by UEs during the one or more COTs.

In some embodiments, these exemplary methods can also include, based on SL communication via the channel during the first COT, sending to the second UE a second message that includes information about sharing the one or more COTs that the first UE is permitted to initiate. In such case, the data is received from the second UE in accordance with the information included in the second message. In some of these embodiments, the information included in the second message comprises one or more of the following:
respective start times, end times, and/or maximum durations of the one or more COTs;
durations within the one or more COTs that are reserved for other UEs to transmit;
SL transmission types allowed during the one or more COTs;
one or more services, LCHs, LCGs, or channel access priority classes allowed during the one or more COTs;
one or more types of signaling and/or data transmissions allowed during the one or more COTs;
one or more types of channel occupancy allowed during the one or more COTs;
one or more LBT categories required or allowed during the one or more COTs;
CP configuration to be used by the second UE during the one or more COTs; and
types of SL grants allowed during the one or more COTs.

In some embodiments, these exemplary methods can also include initiating a second COT of the one or more COTs for the channel in unlicensed spectrum. The second COT is initiated for communication with the RAN node and overlaps at least partially with the first COT.

Other embodiments include exemplary methods (e.g., procedures) for a second UE (e.g., wireless device, IoT device, etc.) configured for SL communication with at least a first UE in a wireless network. These exemplary methods can include receiving a second message that includes information about sharing one or more COTs that the first UE is permitted to initiate for a channel in unlicensed spectrum. These exemplary methods can also include, based on the information in the second message, sending data to the first UE using SL communication via the channel during a first COT, of the one or more COTs, that was initiated by the first UE.

In various embodiments, the second message can be received according to one of the following:
from the first UE using SL communication via the channel in unlicensed spectrum,
from a RAN node using DL communication via the channel in unlicensed spectrum, or
from a RAN node using DL communication via licensed spectrum.

In some of these embodiments, the second message is received from the first UE during the first COT.

In various embodiments, the information included in the second message can include any of the second message information summarized above in relation to first UE embodiments.

Other embodiments include exemplary methods (e.g., procedures) for a RAN node configured to facilitate SL communication between at least first and second UEs in a wireless network. These exemplary methods can also include sending, to the first UE, a first message indicating that the first UE is permitted to initiate the one or more COTs for the channel and to share the one or more COTs with at least the second UE for SL communication.

In some embodiments, these exemplary methods can also include allocating resources for SL communication by at least the first and second UEs during the one or more COTs for the channel in unlicensed spectrum. In some of these embodiments, allocating resources for SL communication can include sending, to the first UE, an allocation of resources for SL communication with at least the second UE during the one or more COTs. In some of these embodiments, allocating resources for SL communication can include sending, to the second UE, an allocation of resources for SL communication with at least the first UE during the one or more COTs that the first UE is permitted to initiate.

In some embodiments, these exemplary methods can also include receiving, from the first UE, a request to initiate a first COT of the one or more COTs and to share the first COT with at least the second UE for SL communication. In such case, the first message is sent in response to the request.

In some embodiments, the allocation of resources is for the first COT and the allocation is sent in response to receiving the request. In other embodiments, the allocation of resources is for a plurality of COTs including the first COT.

In various embodiments, the request received from the first UE can include any of the same contents as summarized above in relation to the first UE embodiments. In various embodiments, the request can be received in any of the ways that it can be sent by the first UE, as summarized above in relation to first UE embodiments.

In various embodiments, the first message can include any of the same contents as summarized above in relation to the first UE embodiments. In various embodiments, the first message can be sent in any of the ways that it can be received by the first UE, as summarized above in relation to first UE embodiments.

In some embodiments, these exemplary methods can also include sending, to the second UE, a second message that includes information about sharing the one or more COTs that the first UE is permitted to initiate. In some embodiments, the second message can be sent using DL communication via the channel in unlicensed spectrum. In other embodiments, the second message can be sent via licensed spectrum. In various embodiments, the second message can include any of the same contents as summarized above in relation to the second UE embodiments.

Other embodiments include UEs (e.g., wireless devices) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein provide flexible and efficient techniques for fast, agile, and/or dynamic control of SL transmissions (e.g., for Type-1 SL configured grant) that can cause interference to other SL transmissions. At a high level, embodiments improve interference management in a wireless network that supports D2D operation via SL, thereby improving performance of networks and UEs operating in unlicensed spectrum.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows exemplary NR user plane (UP) and control plane (CP) protocol stacks.

FIG. 2 illustrates a high-level views of an exemplary 5G/NR network architecture.

FIG. 3 shows an exemplary LTE CCA procedure performed by a UE or network node wanting to transmit on a channel in unlicensed spectrum.

FIGS. 4-5 show two examples of channel occupancy time (COT) sharing between UE and gNB transmissions.

FIG. 6 shows an exemplary frame-based equipment (FBE) channel occupancy operation.

FIG. 7 shows an exemplary arrangement of interfaces between two V2X UEs and a RAN.

FIG. 8 shows three exemplary network coverage scenarios for two UEs and a gNB serving a cell.

FIGS. 9-13 show signaling diagrams of various exemplary procedures between a gNB and first and second UEs, according to various embodiments of the present disclosure.

FIG. 14 shows a flow diagram of an exemplary method for a RAN node (e.g., base station, eNB, gNB, etc.), according to various embodiments of the present disclosure.

FIG. 15 shows a flow diagram of an exemplary method for a first UE (e.g., wireless device), according to various embodiments of the present disclosure.

FIG. 16 shows a flow diagram of an exemplary method for a second UE (e.g., wireless device), according to various embodiments of the present disclosure.

FIG. 17 shows a communication system according to various embodiments of the present disclosure.

FIG. 18 shows a UE according to various embodiments of the present disclosure.

FIG. 19 shows a network node according to various embodiments of the present disclosure.

FIG. 20 shows host computing system according to various embodiments of the present disclosure.

FIG. 21 is a block diagram of a virtualization environment in which functions implemented by some embodiments of the present disclosure may be virtualized.

FIG. 22 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a radio access node or a wireless device.”
Node: As used herein, a “node” can be a network node or a wireless device.
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

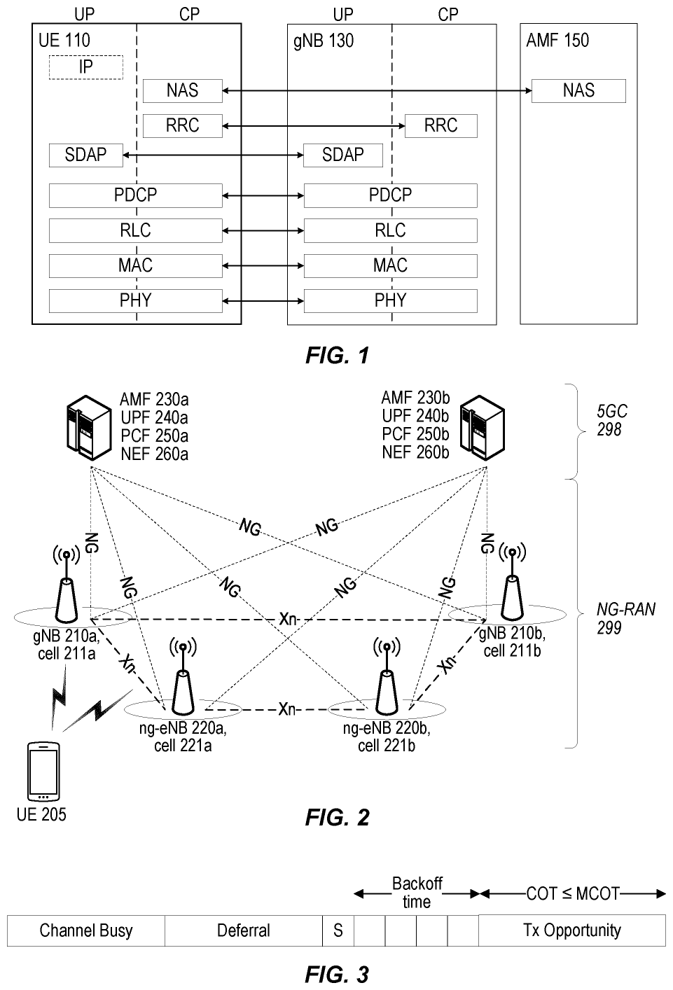

FIG. 1 shows an exemplary configuration of NR user plane (UP) and control plane (CP) protocol stacks between a UE, a gNodeB (gNB, e.g., base station), and an access and mobility management function (AMF) in the 5G core network (5GC). Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for CP and UP.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and establishes, configures, maintains, and releases DRBs and Signaling Radio Bearers (SRBs) used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on physical DL control channel (PDCCH) for pages from 5GC via gNB. A UE in RRC_IDLE state is not known to the gNB serving the cell where the UE is camping. However, NR RRC includes an RRC_INACTIVE state in which a UE is known (e.g., via context) by the serving gNB.

FIG. 2 shows a high-level view of an exemplary 5G network architecture, including a Next Generation Radio Access Network (NG-RAN) 299 and a 5G Core (5GC) 298. As shown in the figure, NG-RAN 299 can include gNBs 210 (e.g., 210a,b) and ng-eNBs 220 (e.g., 220a,b) that are interconnected with each other via respective Xn interfaces. The gNBs and ng-eNBs are also connected via the NG interfaces to 5GC 298, more specifically to the Access and Mobility Management Function (AMF, e.g., 230a,b) via respective NG-C interfaces and to the User Plane Function (UPF, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs 210 can support the NR radio interface including frequency division duplexing (FDD), time division duplexing (TDD), or a combination thereof. In contrast, each of ng-eNBs 220 can support the LTE radio interface but, unlike conventional LTE eNodeBs (eNBs), connect to the 5GC via the NG interface. Each of the gNBs and ng-eNBs can serve a geographic coverage area including one more cells, including cells 211a-b and 221a-b shown as exemplary in FIG. 2. The gNBs and ng-eNBs can also use various directional beams to provide coverage in the respective cells. Depending on the particular cell in which it is located, a UE 205 can communicate with the gNB or ng-eNB serving that cell via the NR or LTE radio interface, respectively.

The gNBs shown in FIG. 2 can include a central (or centralized) unit (CU or gNB-CU) and one or more distributed (or decentralized) units (DU or gNB-DU), which can be viewed as logical nodes. CUs host higher-layer protocols and perform various gNB functions such controlling the operation of DUs, which host lower-layer protocols and can include various subsets of the gNB functions. As such, each of the CUs and DUs can include various circuitry needed to perform their respective functions, including processing circuitry, communication interface circuitry (e.g., for communication via Xn, NG, radio, etc. interfaces), and power supply circuitry. Moreover, the terms “central unit” and “centralized unit” can be used interchangeably, as can the terms “distributed unit” and “decentralized unit.”

A CU connects to its associated DUs over respective F1 logical interfaces. A CU and associated DUs are only visible to other gNBs and the 5GC as a gNB, e.g., the F1 interface is not visible beyond a CU. A CU can host higher-layer protocols such as F1 application part protocol (F1-AP), Stream Control Transmission Protocol (SCTP), GPRS Tunneling Protocol (GTP), Packet Data Convergence Protocol (PDCP), User Datagram Protocol (UDP), Internet Protocol (IP), and Radio Resource Control (RRC) protocol. In contrast, a DU can host lower-layer protocols such as Radio Link Control (RLC), Medium Access Control (MAC), and physical-layer (PHY) protocols.

NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval. An NR slot can also be arranged with various time-division duplexing (TDD) arrangements of UL and DL symbols. These TDD arrangements include:
DL-only (i.e., no UL transmission) slot with transmission late-start in symbol 1;
DL-heavy, with one UL symbol and guard periods before and after the UL symbol to facilitate change of transmission direction;
UL-heavy, with a single UL symbol that can carry DL control information; and
UL-only with transmission on-time start in symbol 0 and the initial UL symbol usable to carry DL control information.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

These RS are carried by various REs within DL RBs, which also carry various DL physical channels such as physical DL control channel (PDCCH), physical DL shared channel (PDSCH), physical broadcast channel (PBCH), etc. A UE can also transmit various UL physical channels and signals that are carried within UL RBs, such as physical UL control channel (PUCCH), physical UL shared channel (PUSCH), physical random access channel (PRACH), sounding RS (SRS), etc.

A UE performs measurements on DL RS (e.g., beams) of one or more cells in different RRC states. Each cell measured by a UE may operate on the same carrier frequency as the UE's serving cell (e.g., an intra-frequency carrier) or it may operate on a different carrier frequency than the UE's current serving cell (e.g., non-serving carrier frequency). The non-serving carrier is often referred to as an inter-frequency carrier if the serving and measured cells belong to the same RAT bit different carrier frequencies, or as an inter-RAT carrier if the serving and measured cells belong to different RATs.

Examples of UE cell measurements include cell identification (e.g., PCI acquisition, PSS/SSS detection, cell detection, cell search, etc), RS Received Power (RSRP), RS Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), acquisition of system information (SI) and/or cell global ID (CGI), RS Time Difference (RSTD), UE RX-TX time difference measurement, and Radio Link Monitoring (RLM, including out-of-sync and in-sync detection).

Besides conventional use in licensed (i.e., exclusive) spectrum, NR networks also can operate in unlicensed bands in shared spectrum, referred to generally as NR-U. Operation in unlicensed bands introduces a unique set of rules intended to promote spectrum sharing with otherwise competing transceivers. These rules promote an etiquette or behavior that facilitates spectrum sharing and/or co-existence. According to a common coexistence technique, for a node (e.g., UE or base station) to be allowed to transmit in unlicensed spectrum, it typically needs to perform a listen-before-talk (LBT) or a clear channel assessment (CCA). For example, in the 5 GHz band, the sensing is done over 20-MHz channels. In general, the MAC layer initiates a transmission and requests the PHY layer to initiate the LBT procedure. After completion, the PHY layer indicates the LBT outcome (e.g., success or failure). This procedure can include sensing the medium as idle for a number of time intervals, which can be done in various ways including energy detection, preamble detection, or virtual carrier sensing.

LBT has become well-known and popular due to ubiquitous use by Wireless LANs (also known as “WiFi”), even though most regulatory agencies did not enforce LBT operation. The introduction of LTE LAA and subsequent definition of LTE LAA regulations ensured LBT functionality was required by all radio transceivers, regardless of whether they were WiFi or LTE LAA. Energy detection (ED) thresholds were defined, simulated, debated, and soon became part of the regulatory specifications to be met by all devices that operate in unlicensed bands.

As an example of energy detection (ED), a channel is assessed to be idle when the received energy or power during the sensing time duration is below a certain ED threshold; otherwise, the channel is considered busy. Regulatory requirements in some regions specify the maximum allowed ED threshold, thus setting a limit on transmitter behavior. An example ED threshold is −72 dBm. In some cases, the ED threshold may depend on the channel bandwidth, e.g., −72 dBm 20 MHz bandwidth, −75 dBm for 10 MHz bandwidth, etc. If the channel is assessed as “busy” then the prospective transmitter (i.e., UE or network node) is required to defer transmission.

FIG. 3 shows an exemplary LTE CCA procedure performed by a UE or network node wanting to transmit on a channel in unlicensed spectrum. In this procedure, the prospective transmitter initially senses the channel busy for some duration. After a deferral period, the transmitter senses the channel to be idle in the period labelled “s” (for sensing). For example, s=25 μs. After a backoff time following the idle sensing, the transmitter has a transmission opportunity (TXOP) or a channel occupancy time (COT) during which it may transmit a signal, with the COT's duration being less than a maximum COT (MCOT) that depends on regional rules or laws, the sensing period s, etc. For example, a typical COT duration is 1-10 ms based on a MCOT of 10 ms. The backoff time may be a deterministic value or a probabilistic value (e.g., selected from a random distribution). 3GPP TR 38.889 (v 16.0.0) specifies the following four categories of channel access schemes for NR-U:
Cat-1 (also referred to as no LBT operation): Immediate transmission after a short switching gap. This is used for a transmitter to immediately transmit after a UL/DL switching gap inside a COT. The switching gap from reception to transmission is to accommodate the transceiver turnaround time and is no longer than 16 μs.
Cat-2 (also referred to as one shot LBT): LBT without random back-off. The duration of time that the channel is sensed to be idle before the transmitting entity transmits is deterministic.
Cat-3: LBT with random back-off with a contention window of fixed size. The transmitting entity draws a random number N within a contention window, whose size is fixed based on the minimum and maximum values of N. The random number N is used in the LBT procedure to determine the duration of time that the channel is sensed to be idle before the transmitting entity transmits on the channel.
Cat-4 (also referred to as dynamic channel occupancy with load based LBE): LBT with random back-off with a contention window of variable size. The transmitting entity draws a random number N within a contention window, whose size is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

Different categories of channel access schemes can be used for different transmissions in a COT and for different channels/signals to be transmitted. NR-U also supports two different LBT modes: dynamic channel occupancy for load based Equipment (LBE) and semi-static channel occupancy for frame based equipment (FBE).

A UE measures RSRP and RSRQ of the DL radio channel (e.g., via SSB or CSI-RS) and provides measurement reports to its serving eNB or gNB. However, these measurements don't reflect the interference strength on the carrier, which is better conveyed by RSSJ. An eNB or gNB can derive RSSI based on received RSRP and RSRQ reports. In unlicensed spectrum, some reports of RSRP or RSRP may not be available due to DL RS transmission being blocked or UL measurement reports being blocked.

Hence, RSSI measurements can be very useful particularly when accompanied by information concerning when and for how long time a UE made the RSSI measurements. For example, such information can assist a gNB or eNB to detect a hidden node that is blocking transmissions. Additionally, such information can assist a gNB or eNB to measure carrier load which is useful for load balancing and avoiding/reducing channel access failures.

For these and other reasons, LTE LAA included measurements of averaged RSSI and channel occupancy in measurement reports. More specifically, channel occupancy is defined as percentage of time that RSSI was measured above a configured threshold. A RSSI measurement timing configuration (RMTC) is provided for such measurements, including a measurement duration (e.g., 1-5 ms) and a period between measurements (e.g., 40, 80, 160, 320, 640 ms). In 802.11 Wi-Fi, data reception acknowledgement (ACK) feedback is transmitted without performing CCA, but a small time duration (called SIFS) is introduced between the data transmission and the corresponding feedback. In 802.11, the SIFS period is defined as:

aSIFSTime=aRxPHYDelay+aMACProcessingDelay+aRxTxTurnaroundTime,

where:
aRxPHYDelay defines the duration needed by the PHY layer to deliver a packet to the MAC layer;
aMACProcessingDelay defines the duration that the MAC layer needs to trigger the PHY layer transmitting a response; and
aRxTxTurnaroundTime defines the duration needed to turn the radio from reception into transmit mode.

Thus, the SIFS duration accommodates hardware delay needed to switch the direction from reception to transmission. It is anticipated that for NR-U, a similar gap to accommodate for the radio turnaround time will be allowed. For example, this will enable the transmission of PUCCH carrying UL control information (UCI, e.g., ACK feedback) as well as PUSCH carrying data and possibly UCI within the same transmit opportunity (TXOP) acquired by the initiating gNB without the UE performing CCA before PUSCH/PUCCH transmission, so as long as the gap between DL and UL transmission is less than or equal to the SIFS duration (e.g., 16 microseconds).

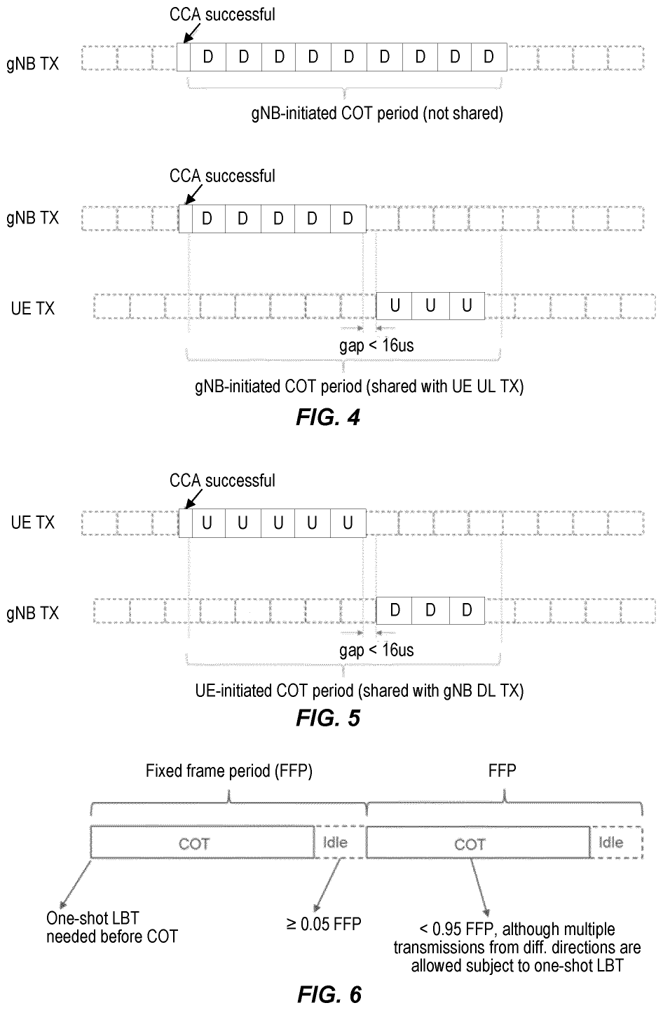

This type of operation is often called “COT sharing” and is illustrated in FIG. 4. In particular, the top-most line illustrates a non-shared gNB-initiated COT period after successful CCA, while the bottom two lines illustrate a gNB-initiated COT period shared with UE UL transmissions after a successful CCA by the gNB.

When UE accesses medium via Cat-4 LBT with a configured (i.e., non-dynamic) grant outside of a gNB COT, it is also possible for UE and gNB to share the UE-acquired COT between UL data transmitted by the UE and DL data scheduled for transmission to the UE. For example, the UE can indicate COT information in UCI, such as CG-UCI for configured grant PUSCH resources. FIG. 5 shows an example of a UE-initiated COT period shared with gNB DL transmissions after a successful CCA by the UE.

Dynamic channel occupancy with load based LBE (i.e., Cat-4 LBT) is also called Type 1 channel access in 3GPP TS 37.213 (v 17.0.0), which describes it in more detail as follows. A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5.

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission.

If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}, which consists of duration T_{f}=16 us immediately followed by my consecutive slot durations of Tₛₗ=9 us each. An idle slot duration Tₛₗ is also at start of T_{f}.

The contention window CWp is defined as CW_{min,p}≤CWₚ≤CW_{max,p} and is adjusted as described in 3GPP TS 37.213 section 4.2.2. CW_{min,p} and CW_{max,p} are chosen before step 1 of the procedure above. Also, mₚ, CW_{min,p}, and CW_{max,p} are based on a channel access priority class p as defined in 3GPP TS 37.213 (v 17.0.0) Table 1/Table 4.2.1-1.

In contrast, semi-static channel occupancy allows a frame based equipment (FBE) to perform a CCA per fixed frame period for a duration of a single 9 us observation slot. If the channel is found to be busy after CCA, the FBE shall not transmit during this fixed frame period. The fixed frame period can be set to a value between 1 and 10 ms and can be adjusted once every 200 ms. If the channel is found to be idle, the FBE can transmit immediately up to the duration of the COT, after which the equipment shall remain silent for at least 5% of the COT. At the end of the required silent period, the FBE can resume CCA for channel access. FIG. 6 shows an example of FBE channel occupancy operation.

Semi-static channel occupancy generally has difficulty competing with devices that use dynamic channel occupancy (such as LAA or NR-U) for channel access for various reasons. First, dynamic channel occupancy provides flexibility to access the channel at any time after a successful LBT procedure, while semi-static channel occupancy provides one chance to grab the channel every FFP. These problems become greater with longer FFP and higher traffic load. Second, FBE-based LBT can be rather inflexible for coordinating channel access between networks. If all nodes are synchronized, they will find the channel available and transmit simultaneously, resulting in interference. If all nodes are not synchronized, then some may have advantages in getting access to the channel.

Nevertheless, semi-static channel occupancy can be good choice for controlled environments, where a network owner can guarantee absence of dynamic channel occupancy devices and is in control of the behavior of all devices competing to access the channel. In such a deployment, semi-static channel occupancy is an attractive solution because access latencies can be reduced to the minimum and lower complexity is required for channel access due to no random backoff.

Even for a single-operator FBE system, all gNBs need to be time aligned such that they perform the one-shot 9 μs LBT at the same time. If a gNB indicates FBE operation for LBT Cat-2 (25 us) or Cat-4, a UE measures one 9 μs slot within a 25 μs interval.

A FFP is restricted to values of 1, 2, 2.5, 4, 5, and 10 ms including the idle period. FFPs start at even-numbered radio frames (e.g., every second radio frame) and are given by i*P, where i={0, 1, . . . , 20/P−1} and P is FFP in ms. The idle period for a given SCS=ceil(minimum idle period allowed by regulations/Ts), where Ts is the symbol duration for the given SCS and minimum idle period allowed=max(5% of FFP, 100 us).

For FBE, channel sensing is performed at fixed time instants. If the channel is determined busy, the base station adopts a fixed back-off and perform LBT again after the fixed backoff. For LBE, channel sensing can be performed at any time instance, and random back-off is adopted when the channel is determined to be busy.

When it can be guaranteed that LBE nodes are absent (e.g., by level of regulation) and gNBs are synchronized, an FBE system can achieve unity (1) frequency reuse factor and lower complexity for channel access due to lack of necessity to perform random backoff. LBE may have different benefits in similar scenarios due to its different mode of operation. Moreover, FBE may also have some disadvantages compared to other modes such as LBE, including a fixed overhead of idle time during a frame.

In NR Rel-16, only gNB-initiated COT sharing is supported for semi-static channel access by FBE. A UE may transmit UL burst(s) after gNB DL transmission within a gNB-initiated COT, i.e., if gNB DL transmissions are detected within the FFP. In other words, detection of any gNB DL transmissions confirms that the gNB has initiated the COT. For this to work, UEs should be aware of start and end of every FFP cycle. Such UE behaviors are not optimum for URLLC-type services with strict latency requirements. Thus, FBE-based solutions with UE-initiated COT would be a complementary for URLLC.

As briefly mentioned above, 3GPP Rel-16 specifies the NR sidelink (SL) interface and targets advanced V2X services including use cases such as vehicles platooning, extended sensors, advanced driving, and remote driving. The advanced V2X services require a new SL to meet service requirements of low latency and high reliability. The NR SL is designed to provide higher system capacity and better coverage, and to allow for extension to support the future development of even more advanced V2X services and other related services.

In general, a V2X UE can support unicast communication via the uplink/downlink radio interface (also referred to as “Uu”) to a 3GPP RAN, such as the LTE Evolved-UTRAN (E-UTRAN) or the NG-RAN. A V2X UE can also support SL unicast over the PC5 interface.

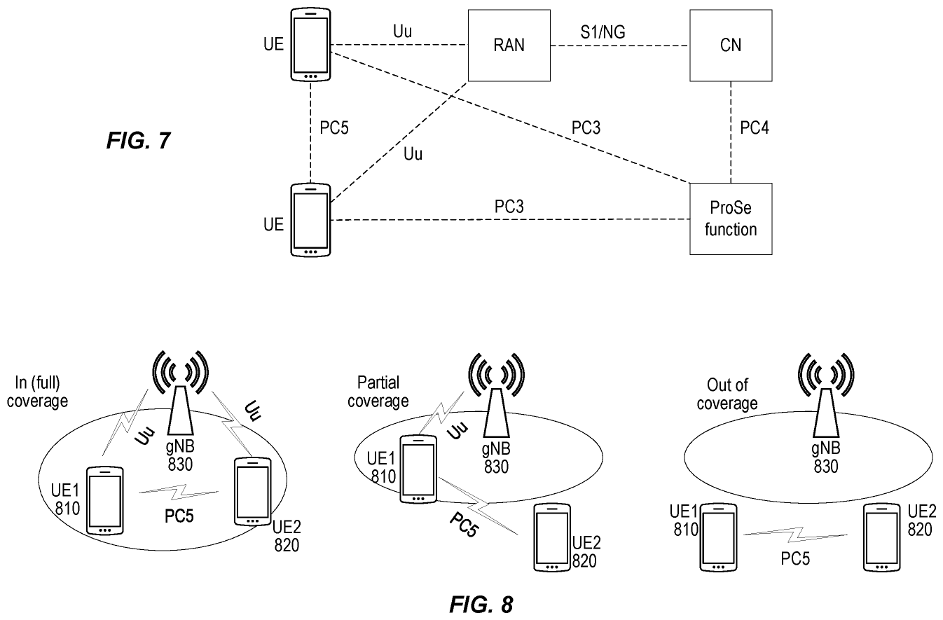

FIG. 7 shows an exemplary arrangement of interfaces between two V2X UEs and a RAN. In addition to Uu and PC5 interfaces, the V2X UEs can communicate with a ProSe (PROximity-based SErvices) network function (NF) via respective PC3 interfaces. Communication with the ProSe NF requires a UE to establish a connection with the RAN, either directly via the Uu interface or indirectly via PC5 and another UE's Uu interface. The ProSe function provides the UE various information for network related actions, such as service authorization and provisioning of PLMN-specific information (e.g., security parameters, group IDs, group IP addresses, out-of-coverage radio resources, etc.).

FIG. 8 shows three exemplary network coverage scenarios for two UEs and a gNB serving a cell. In the full coverage scenario (left), both UEs are in the coverage of the cell, such that they both can communicate with the gNB via respective Uu interfaces and directly with each other via the PC5 interface. In the partial coverage scenario (center), only one of the UEs is in coverage of the cell, but the out-of-coverage UE can still communicate with the gNB indirectly via the PC5 interface with the in-coverage UE. In the out-of-coverage scenario, both UEs can only communicate with each other via the PC5 interface.

In general, the term “SL standalone” refers to direct communication between two SL-capable UEs (e.g., via PC5) in which source and destination are the UEs themselves. In contrast, the term “SL relay” refers to indirect communication between a network node and a remote UE via a first interface (e.g., Uu) between the network node an intermediate (or relay) UE and a second interface (e.g., PC5) between the relay UE and the remote UE. In this case the relay UE is neither the source nor the destination.

In general, an “out-of-coverage UE” is one that cannot establish a direct connection to the network and must communicate via either SL standalone or SL relay. UEs that are in coverage can be configured (e.g., by a gNB) via RRC signaling and/or system information. Out-of-coverage UEs rely on a (pre-)configuration available in their SIMs. These pre-configurations are generally static but can be updated by the network when a UE is in coverage. A “peer UE” refers to a UE that can communicate with the out-of-coverage UE via SL standalone or SL relay (in which case the peer UE is also a relay UE).

NR SL also includes enhanced channel sensing and resource selection procedures relative to the LTE LAA. NR SL also provides congestion control and QoS management to achieve a higher connection density than LTE LAA. To enable these and other enhancements, NR SL includes the following new physical channels and RS):
PSSCH (Physical SL Shared Channel, SL version of PDSCH): PSSCH is transmitted by a SL transmitter UE, and conveys SL, SIBs for RRC configuration, and a part of the SL control information (SCI, SL version of DL control information).
PSFCH (Physical SL feedback channel): The PSFCH is transmitted by a SL receiver UE for unicast and groupcast, and conveys one bit information over one RB for HARQ ACK or NACK. In addition, CSI is carried in a MAC control element (CE) over PSSCH instead of via PSFCH.
PSCCH (Physical SL Common Control Channel, SL version of PDCCH): When traffic to be sent to a receiver UE arrives at a transmitter UE, it should first send the PSCCH to convey a part of SCI to be decoded by any UE for channel sensing purpose. This part of SCI includes reserved time-frequency resources for transmissions, DMRS pattern and antenna port, etc.
SL Primary/Secondary Synchronization Signal (S-PSS/S-SSS): SL primary and secondary synchronization signals (S-PSS and S-SSS, respectively) are supported similar to DL PSS/SSS. By detecting S-PSS and S-SSS, a UE is able to identify the SL synchronization identity (SSID) of the sending UE (called “synchronization source”) and its associated characteristics. A process of acquiring timing and frequency synchronization and UE SSIDs is called initial cell search. Note that the UE sending S-PSS/S-SSS may not be necessarily involved in other SL transmissions. There are two S-PSS sequences and 336 S-SSS sequences, forming a total of 672 SSIDs in a cell.
Physical SL Broadcast Channel (PSBCH): PSBCH is transmitted along with the S-PSS/S-SSS as a synchronization signal/PSBCH block (SSB). The SSB has the same numerology as PSCCH/PSSCH on that carrier, and should be transmitted within the bandwidth of the configured bandwidth part (BWP). PSBCH conveys synchronization-related information such as direct frame number (DFN), indication of the slot and symbol level time resources for SL transmissions, in-coverage indicator, etc. SSB is transmitted every 160 ms.
DMRS, PT-RS, CSI-RS: These RS supported by NR DL are also supported on NL SL, including that PT-RS is only applicable for transmissions in frequency range 2 (FR2, e.g., above 6 GHz).

As mentioned above, unlike DCI on PDCCH, only a first part of SCI is sent on PSCCH. This first part is used for channel-sensing purposes and can be read by all UEs. The second part is sent on PSSCH and includes scheduling and control information such as an 8-bit source ID, 16-bit destination ID, new data indicator (NDI), redundancy version (RV), and HARQ process ID. This second part can be decoded only by the intended receiver UE.

Two types of resource allocation modes are supported for NR SL between UEs. In NR SL resource allocation mode 1, all SL transmissions between UEs are scheduled by the network (e.g., a serving gNB) using a configured grant or a dynamic grant, which are described below.

When the traffic to be sent over SL arrives at a transmitter UE, this UE launches a four-message procedure to request SL resources from a gNB: UL scheduling request (SR), DL grant for buffer status report (BSR), UL BSR, and DL grant for data comprising BSR. During the resource request procedure, a gNB may allocate a SL radio network temporary identifier (SL-RNTI) to the transmitter UE. If a SL resource request is granted, the gNB indicates the resource allocation for PSCCH and the PSSCH in DCI on PDCCH with a CRC scrambled with the SL-RNTI. When a transmitter UE receives such a DCI, it can obtain the grant only by descrambling the CRC using the assigned SL-RNTI. A transmitter UE then indicates the time-frequency resources and the transmission scheme of the allocated PSSCH in the PSCCH, and launches PSCCH and PSSCH on the resources allocated for SL transmissions. A transmitter UE can only transmit a single TB on a grant obtained from a gNB, making dynamic grants suitable only for traffic with loose latency requirements.

For the traffic with a strict latency requirement, performing the four-message exchange procedure to request SL resources induces unacceptable latency. Thus, prior to anticipated traffic arrival, a transmitter UE may request a set of resources via the four-message exchange procedure mentioned above. The gNB can reserve periodic SL resources according to the request and convey this to the UE in a SL configured grant, similar to an UL configured grant. When the anticipated traffic arrives, the transmitter UE can launch the PSCCH and the PSSCH during the next occasion of the resources of the configured grant. This process is also known as grant-free transmission.

The network (e.g., gNB) can provide a UE with SL configured grant via radio resource control (RRC) configuration. SL configured grants typically allocate resources having a periodic, semi-persistent pattern. Two types of configured SL grants are available, i.e., types 1 and 2. In type 2, the network can activate/deactivate the RRC-configured grant using DCI signaling. In other cases, the network may select the resources used for transmission but may give the transmitting SL UE some freedom to select some of the transmission parameters, possibly with some restrictions

In SL resource allocation mode 2, the resource allocation is performed by UE itself, e.g., autonomously based on sensing the carrier/resource pool for availability. In particular, the UE determines SL resource pool(s) by decoding sidelink control information (SCI) received from other UEs and/or by energy sensing, and selects a set of idle/available resources to use for its transmission of PSCCH and PSSCH. In this mode, there may be no intervention by the network (e.g., out of coverage, unlicensed carriers without a network deployment, etc.) or very minimal intervention by the network (e.g., configuration of pools of resources, etc.).

To further minimize the latency of the HARQ ACK/NACK feedback and subsequent retransmissions, the transmitter UE may also reserve PSCCH/PSSCH resources for retransmissions. To improve probability of successful one-shot transport block (TB) decoding and thereby reduce retransmissions, the transmitter UE may repeat a TB transmission prior to receiving HARQ feedback—a mechanism known as blind retransmission. Thus, when traffic arrives at a transmitter UE, it should select resources for PSSCH associated with PSCCH for initial transmission and blind retransmissions, and PSSCH associated with the PSCCH for retransmissions.

Since each SL transmitter UE autonomously selects resources in mode 2 as described above, there is a need to prevent different transmitter UEs from selecting the same resources. One mode-2 resource selection procedure is based on a channel sensing technique that involves measuring RSRP on different subchannels. This technique requires knowledge of DMRS power levels for different UEs on PSSCH or PSCCH, depending on the configuration. This information is known only after receiving SCI from all other UEs, and adds to the overall complexity of this channel sensing and selection technique.

For both dynamic and configured SL grants, a SL receiver UE cannot decode a DCI containing the grant since it is addressed to the transmitter UE's SL-RNTI. Thus, the receiver UE must perform blind decoding to identify the presence of PSCCH and to decode SCI that indicates resources for PSSCH. However, when a transmitter UE launches the PSCCH, it inserts CRC in the SCI without any scrambling.

It is expected that 6G wireless systems and further enhancements to 5G systems will address high-data-traffic consumer use cases such as AR, VR, XR, cloud gaming, etc. Moreover, it is expected that 6G and/or enhanced 5G will address many of these use cases based on D2D communication since it can provide higher data rates, lower latency, improved reliability, reduced energy consumption, etc. as compared to communication via network nodes.

Furthermore, it is expected that 6G and/or enhanced 5G will use higher-frequency spectrum such as 100-300 GHz and beyond, which is generally referred to as “millimeter wave” (or mmW for short). UE-to-UE and UE-to-network transmissions have higher path loss in mmW spectrum compared to lower frequencies, and typically must be carried over narrow, high-gain beams. Additionally, it is expected that most mmW bands will operate as shared or unlicensed spectrum (also referred to as licensed-exempt spectrum).

Currently, however, NR-U channel access rules are specified for UL and DL communication between UE and network (i.e., Uu interface) but not for SL communication between UEs. This can cause various problems, issues, and/or difficulties, particularly for sharing a channel occupancy time (COT) initiated and/or obtained by a first UE (e.g., via CCA) with a second UE engaged in SL D2D communication with the first UE.

3GPP Rel-17 includes a restriction that a UE cannot share its COT with another UE (at least for FBE) for communication over the Uu interface towards the network. Even so, this restriction cannot apply to SL communication over PC5; otherwise, a UE cannot establish SL communication. Thus, a new solution is required for sharing UE-initiated COT in SL communication.

Another issue is related to SL transmission in mode 2, where resources are pre-configured by the network and a UE can autonomously transmit on SL to other UEs using the pre-configured resources. If multiple UEs initiate a COT on the pre-configured resources concurrently, then then this will cause interference that cannot be controlled by the network.

Another issue is related to SL transmission in mode 1. For a Type-2 SL configured grant, the network can suspend a SL transmission by deactivation DCI. This is not possible for a Type-1 SL configured grant; rather, a UE-initiated SL COT may be suspended by RRC reconfiguration, which has a large latency or delay. Since the network does not have dynamic control of UE-initiated COT under Type-1 SL configured grant, the transmissions of multiple UEs may collide and cause interference.

Accordingly, embodiments of the present disclosure provide flexible and efficient techniques for network control of UE initiation and sharing of SL COT with other UEs. These techniques are generally applicable to scenarios where a UE obtains a COT based on CCA in unlicensed or shared spectrum, e.g., in a channel for which such operations are required and/or mandated. Embodiments provides various benefits and/or advantages, including fast, agile, and/or dynamic control of SL transmissions (e.g., for Type-1 SL configured grant) that can cause interference to other SL transmissions. At a high level, embodiments improve interference management in a wireless network that supports D2D operation via SL.

Although embodiments are described in the context of two or more SL UEs deployed in one or more NR cells, underlying principles are equally applicable to LTE or any other technology that enables D2D communication of two (or more) proximate UEs. Underlying principles are also applicable to relay scenarios such as UE-to-network or UE-to-UE relay, where a remote UE and a relay UE may communicate via LTE or NR PC5 interface, and the Uu interface between relay UE and the network may be LTE or NR.

Embodiments are described below in the context of an exemplary arrangement of first and second UEs (referred to as UE1 and UE2, respectively) operating in unlicensed spectrum in a cell served by a gNB. UE1 initiates a SL COT based on CCA in unlicensed spectrum and, according to different embodiments, shares the SL COT with UE2 either autonomously or under control of the gNB. After UE1 determines to share the SL COT with UE2, UE1 sends LBE/FBE information over PSCCH/PSSCH to at least UE2.

In some embodiments, UE1 requests permission from the gNB for initiating a COT. In response, the gNB allows a UE to initiate one SL COT, multiple SL COTs, or one or more SL COTs during a specified period of time. In another alternative, the gNB can suspend a UE from initiating one SL COT, multiple SL COTs, or any SL COTs during a specified period of time.

In some embodiments, upon receiving the permission from the gNB, UE1 initiates a COT for its own SL transmission, but it does not share the COT with UE2. Thus, UE2 can receive SL transmission from UE1 in the COT but cannot transmit to UE1 in the COT. In other embodiments, upon receiving the permission from the gNB, UE1 initiates a COT for its own SL transmission and shares the COT with UE2. Thus, UE2 can receive SL transmission from UE1 in the COT and can transmit to UE1 in the COT.

In some embodiments, UE1 requests from the gNB permission to share a UE1-initiated COT with UE2. The request for sharing can be implicit in the request for initiating the COT, or it can be explicit and/or separate from the request for initiating the COT.

In some embodiments, parameters related to the COT sharing can be indicated to UE1 in the permission provided by gNB. In other embodiments, the parameters can be pre-configured. In other embodiments, UE1 autonomously determine and/or select the parameters related to COT sharing. In some embodiments, UE2 can obtain the parameters related to the COT sharing from UE1 (via SL) or from the gNB (via DL).

In various embodiments, UE1's request for permission to initiate a SL COT and/or to share the UE1-initiated SL COT with other UEs (e.g., UE2) can include one or more of the following:
start time of the shared COT;
end time of the shared COT;
maximum duration of the shared COT;
durations within the shared COT that are reserved for other UEs to transmit;
ID of UE that initiated the shared COT (i.e., UE1);
group ID(s) allowed to share the COT for groupcast;
IDs of other UEs that are allowed to share the COT;
SL transmission types (i.e., unicast, groupcast, and/or broadcast) allowed during the shared COT;
one or more services, logical channels (LCHs), logical channel groups (LCGs), channel access priority classes, etc. allowed during the shared COT;
type(s) of signaling and/or data transmissions allowed during the shared COT;
LBT category(ies) required or allowed during the shared COT:
   UE2 can skip LBT prior to its transmissions (i.e., cat-1 LBT);
   UE2 needs to perform cat-2 LBT prior to its transmissions; or
   UE2 needs to perform cat-3 or cat-4 LBT prior to its transmissions.
CP configurations for other UEs that share the COT, e.g., whether CP extension is enabled and how CP extension is performed by the other UEs prior to their transmissions when occupying the COT; and
types of SL grants allowed during the shared COT, e.g., dynamic grant, configured grant mode 1, or configured grant mode 2.

In various embodiments, UE1's request for permission to initiate a SL COT and/or to share the UE1-initiated SL COT with other UEs (e.g., UE2) can be sent according to various options, including the first through sixth options (i.e., options 1-6) described below.
First option: dedicated RRC signaling, either in an existing RRC message or a newly-defined RRC message.
Second option: MAC CE, either in an existing MAC CE or a newly-defined MAC CE.

In a third option, UE1 initiates a random access (RA) procedure to carry the request, e.g., in a scheduling request (SR) message. For example, in a four-step RA procedure, msg1 can carry the request. As a more specific example, specific preamble(s) or specific RACH occasion(s) may be allocated for indicating a request for COT initiation and/or sharing. The allocation may be pre-defined, determined based on a pre-defined rule, or configured by the gNB (e.g., in broadcast SI). As another example, msg3 in the four-step RA can carry the request. As a more specific example, UE1 MAC entity adds a request indicator to a field in a MAC subheader or in a MAC CE.

As another example, in a two-step RA procedure, specific preamble(s), specific RACH occasion(s), and specific PUSCH occasions or resources may be allocated for indicating a request for COT initiation and/or sharing. Alternatively, a request indication can be included in MsgA payload, such as a field in a MAC subheader or in a MAC CE.

As another example, an RRC message sent by UE1 during a RA procedure can carry the request for COT initiation and/or sharing.

In a fourth option, the UE initiates a PUCCH transmission to carry the request. Specific PUCCH resources may be allocated for indicating a request for COT initiation and/or sharing. For example, the request could be a PUCCH-scheduling request (SR) message.

In a fifth option, the UE initiates a configured grant-based transmission on PUSCH to carry the request. Specific UL configured grant resources may be allocated for indicating a request for COT initiation and/or sharing. Alternatively, the request may be included in CG UCI.

As a variant of options 4-5, the UE can transmit the request in PUCCH-UCI that can be carried in PUCCH or multiplexed with PUSCH.

In a sixth option, the UE can transmit the request in a control protocol data unit (PDU) for PDCP, SDAP, or RLC. In case of SL relay, the UE can also transmit the request in an adaptation layer PDU.

In various embodiments, the gNB's response to (e.g., granting) UE1's request for COT initiation and/or sharing can be sent according to various options, including:
dedicated RRC signaling, either in an existing RRC message or a newly-defined RRC message;
control protocol data unit (PDU) for PDCP, SDAP, or RLC. In case of SL relay, the UE can also transmit the request in an adaptation layer; or
DCI on PDCCH, either by repurposing an existing DCI field or by a newly-defined DCI field, a newly-defined DCI format, etc.

In some embodiments, the gNB can also provide parameters related to the permitted COT initiation and/or sharing. In some variants, this can be included in the response to UE1's request. Alternately, the parameters can be sent separately and/or not in response to UE1's request, such as broadcast in SIB or MIB, unicast RRC message to UE1, scheduling DCI (e.g., format 3_x), DCI over GC-PDCCH (e.g., to UE1 and UE2), etc. In various embodiments, the provided parameters can include one or more of the following:
LBE channel access parameters, such as priority class, CW window, CP extension, etc.;
FBE channel access parameters;
FBE COT duration;
switching between LBE/FBE operation;
information about wideband Mode 1 or wideband Mode 2 operation;
indication of FBE COT initiator (e.g., whether UE1 or another node);
LBT category;
type of sensing (e.g., 0 or 9 us);
cyclic prefix (CP) extension; and
ED threshold.
   In some variants, UE1 can determine at least some of the parameters autonomously. For example, if UE1 allocates a transmission resource to UE2, then UE1 can indicate the type of LBT UE2 must perform before using the allocated transmission resource.

In various embodiments, a UE's permission request can be transmitted on PUSCH or PUCCH in licensed (e.g., NR operation) or unlicensed (e.g., NR-U) spectrum, and the gNB's response can be transmitted on PDSCH or PDCCH in licensed (e.g., NR) or unlicensed (e.g., NR-U) spectrum.

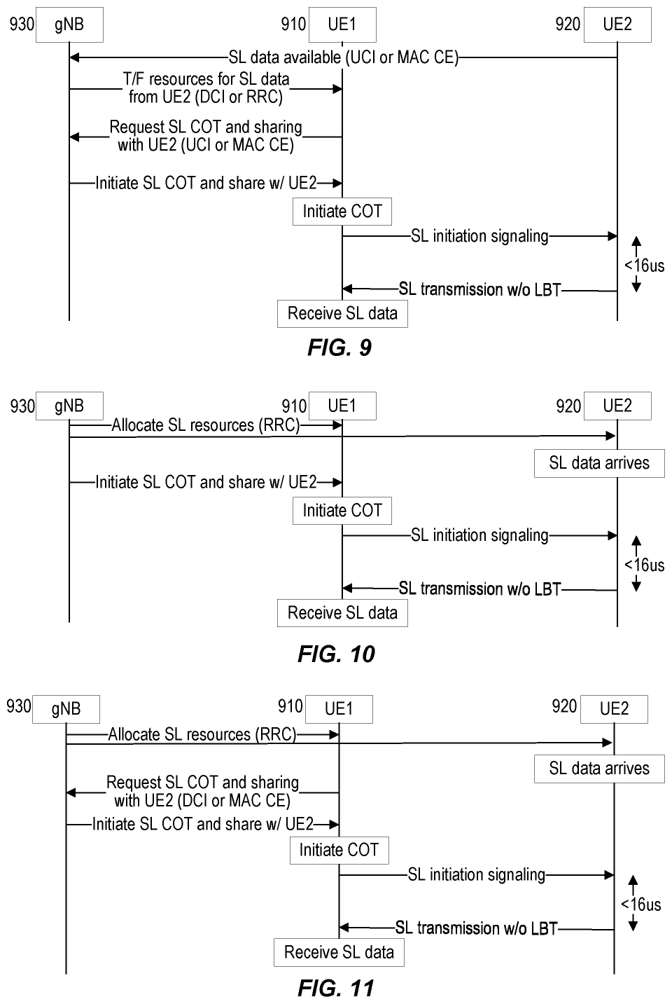

FIG. 9 shows a signaling diagram of an exemplary procedure between the gNB (930), UE1 (910), and UE2 (920), according to some embodiments of the present disclosure. In the illustrated scenario, data for SL transmission arrives at UE2, which informs the gNB about the available data via UCI or MAC CE. The gNB then informs UE1 about the SL data available at UE2 and provides time and/or frequency resources for SL transmission of the data. This information can be sent, for example, via DCI or RRC. In response, UE1 requests permission to initiate SL COT and share with UE2. This request can be sent, for example, via UCI or MAC CE.

The gNB responds with the requested permission, after which UE1 initiates the COT and sends the COT information (e.g., indication of allocated resources) to UE2 via SL signaling. Finally, UE2 transmits the available data via SL to UE1 during the shared COT. Note that in the example shown in FIG. 9, the time between UE2 receiving the COT information from UE1 and transmitting the SL data is less than 16 μs, such that UE2 does not need to perform LBT before transmitting the SL data.

In this manner, the exemplary procedure shown in FIG. 9 enables UE1 and UE2 to communicate via SL over scheduled or configured resources during a COT that has been initiated by UE1. The UE1 signaling to initiate an FBE COT (after idle period) can be via PSSCH, via PSCCH, via GC-PSCCH, DMRS transmission, other RS transmission, orphan symbol transmission, etc.

In some embodiments, the gNB may have previously allocated resources to UE1 and UE2, e.g., via RRC configuration. Based on this knowledge of allocated resources, the gNB requests UE1 to initiate a COT and/or share a COT with UE2. The request can be sent by DCI, e.g., by re-purposing existing bits, by newly-defined bits in an existing DCI format, or by a newly-defined DCI format. The DCI can also indicate whether UE1 is permitted to share the COT with other UEs, or with specific UE(s) such as UE2.

In some embodiments, UE1 initiates the COT after receiving the request. Alternately or additionally, UE1 can respond to the gNB with an indication of whether it can initiate the COT as requested.

In some embodiments, the gNB can also provide parameters related to the requested COT initiation and/or sharing, such as any of the parameters discussed above. In some variants, the parameters can be included with the request to UE1. Alternately, the parameters can be sent separate from the request, such as broadcast in SIB or MIB, unicast RRC message to UE1, scheduling DCI (e.g., format 3_x), DCI over GC-PDCCH (e.g., to UE1 and UE2), etc.

For example, the gNB can use a bitfield in DCI format 3_X, where different values (or indices) of the bitfield map to different combinations of values for channel access type (e.g., semi-static access or dynamic access), COT initiator type (e.g., gNB based, UE based), CP extension, etc. As another example, the gNB can use a similar approach for DCI format 2_0 to convey COT duration for SL UEs.

FIG. 10 shows a signaling diagram of another exemplary procedure between gNB (930), UE1 (910), and UE2 (920), according to other embodiments of the present disclosure. In the illustrated scenario, the gNB allocates time/frequency resources for SL transmission via RRC, so the gNB is aware of when UE2 should transmit arriving data via SL. Prior to an occasion of the allocated resources, the gNB sends UE1 a command to initiate SL COT and share with UE2. Similar to the procedure shown in FIG. 9, UE1 initiates the COT and sends the COT information (e.g., indication of allocated resources) to UE2 via SL signaling. Finally, UE2 transmits the available data via SL to UE1 during the shared COT. Similar to FIG. 9, the time between UE2 receiving the COT information from UE1 and transmitting the SL data is less than 16 μs, such that UE2 does not need to perform LBT before transmitting the SL data.

FIG. 11 shows a signaling diagram of another exemplary procedure between gNB (930), UE1 (910), and UE2 (920), according to other embodiments of the present disclosure. In the illustrated scenario, the gNB allocates time/frequency resources for SL transmission via RRC, so UE1 is aware of when UE2 should transmit arriving data via SL. Prior to an occasion of the allocated resources, UE1 sends the gNB a request to initiate SL COT and share with UE2.

The gNB responds with the requested permission, after which UE1 initiates the COT and sends the COT information (e.g., indication of allocated resources) to UE2 via SL signaling. Finally, UE2 transmits the available data via SL to UE1 during the shared COT. Similar to the procedures shown in FIGS. 9-10, the time between UE2 receiving the COT information from UE1 and transmitting the SL data is less than 16 μs, such that UE2 does not need to perform LBT before transmitting the SL data.

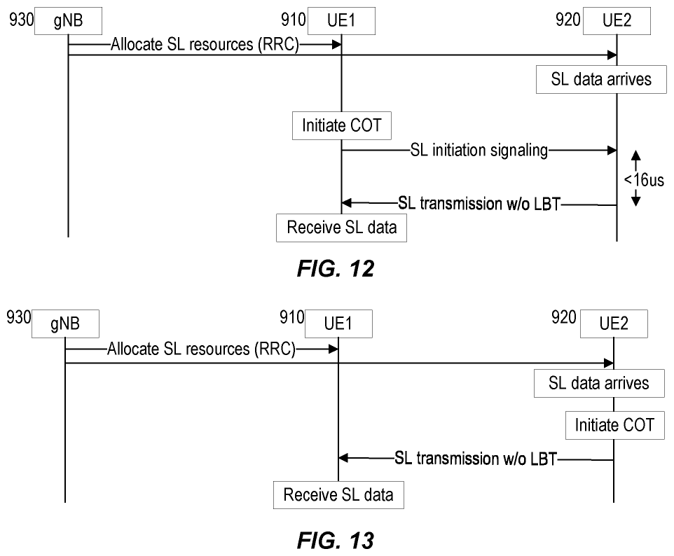

FIG. 12 shows a signaling diagram of another exemplary procedure between gNB (930), UE1 (910), and UE2 (920), according to other embodiments of the present disclosure. In the illustrated scenario, the gNB allocates time/frequency resources for SL transmission via RRC, so UE1 is aware of when UE2 should transmit arriving data via SL. Subsequently, UE1 initiates a COT without direct coordination with the gNB as in other scenarios discussed above. The remainder of the operations shown in FIG. 12 are substantially similar to corresponding operations shown in FIGS. 9-11.

FIG. 13 shows a signaling diagram of another exemplary procedure between gNB (930), UE1 (910), and UE2 (920), according to other embodiments of the present disclosure. In the illustrated scenario, the gNB allocates time/frequency resources for SL transmission via RRC. When data for SL transmission (e.g., to UE1) arrives at UE2, it initiates a COT without direct coordination with the gNB in a similar manner as UE1 in FIG. 12. However, UE2 does not share the COT with UE1.

For SL configured grants (Type 1 or Type 2), the gNB can determine whether FBE COT is initiated by the gNB or a UE (e.g., UE1) based on a pattern and/or periodicity of the SL configured grant. For example, if the SL configured grant is after an idle period, the gNB can determine that a UE should initiates the COT. As another example, if transmissions or repetitions from the same HARQ process are spilling over from a previous COT to a next subsequent COT (e.g., immediately after an idle period), the gNB can determine that a UE should initiates the COT.

Alternately, the gNB can determine that it should initiate COT for SL configured grants allocated immediately following an idle period. In this scenario, a SL UE does not have the right to transmit over the part of the SL configured grant. In one example, if the SL configured grant is after idle period of the COT, the gNB may stop the UE from initiating the COT or cancel the UE's permission to initiate the COT.

In various embodiments, the gNB can define the FBE COT initiating behavior (e.g., UE initiated COT behavior) for SL Mode 1 (dynamic or configured grants) and/or Mode 2 (UE-autonomous resource selection). Some examples are discussed below.

In some embodiments, for a UE initiating COT in Mode 1, all SL grants are typically first granted by the gNB to a SL transmitter. In these grants, the gNB can include information about UE COT initiating behavior (e.g., whether a dynamic grant is associated with gNB COT or UE COT) and channel access information (e.g., LBT categories in FBE or LBE mode).

In some of these embodiments, the information about UE COT initiating behavior and the channel access information can be semi-statistically configured via RRC. In other embodiments, this information can be sent to a UE via DCI. For example, DCI formats 3_0 and 3_1 can be used to send both the SL grant and the information regarding UE COT initiating behavior. As a more specific example, fields such as resource pool index, time resource assignment, frequency resource assignment, padding bits can be used to indicate COT initiation. Alternately, a new field can be added to DCI format 3_0/3_1 or existing fields can be repurposed to carry information about UE COT initiating behavior.

For example, in FBE mode, the gNB can indicate to a UE initiating COT (e.g., UE1) whether LBT Cat-1, Cat-2, or some newly defined category (e.g., cat-X) is applicable. For example, for Cat-1 there is no sensing required if gap ≤16 μs, and for Cat-2 the gap ≥25 μs and 9 μs sensing is required before SL transmission. An exemplary newly-defined LBT category can include a gap ≥G1 μs and S1 μs sensing required before transmission. This type of behavior can be coupled with gNB-COT initiation behavior, but it can also be coupled with behavior of another node initiating COT.

As a more specific example, an existing or new field in DCI format 3_0/3_1 can be used to indicate COT initiation behavior related to ChannelAccess-CPext, ChannelAccessMode (semi static or dynamic), initiation of channel access occupancy (gNB or SL UE). A bit field in the DCI can include different index values that specify different behavior, e.g., a value that indicates channel access type is semi static, CP extension is 0, and COT initiator is SL UE.

In some embodiments, for a UE initiating COT in SL Mode 2, the information about UE COT initiating behavior can be included in Mode 2 resource pool configuration, e.g., via RRC, or DCI, or SCI (from one UE to another). In this resource pool configuration, the gNB can indicate COT type (LBE/FBE), COT periodicity, COT duration, COT initiator node(s), etc. For example, the gNB can initiate the COT but then permit UE autonomous resource selection and transmission during the COT. Alternately, the information about UE COT initiating behavior can be provided to UEs separately from the Mode 2 resource pool configuration.

After a UE autonomously selects resources for SL transmission in Mode 2, it should selectively perform LBT according to the specified LBT category (e.g., Cat-1, Cat-2, or new Cat-X for FBE) before transmitting a SL transmission, depending on the gap between the SL transmission and the previous transmission in the COT. The previous transmission can be a SL transmission (including initiation or non-initiation transmission), a DL transmission, or any other identifiable transmission.

In some embodiments, the UE selectively performs LBT depending on its own understanding of the gap. In such embodiments, rules for LBT category selection must be provided to the UE beforehand, such as via RRC, broadcast SIB, DCI, etc. These rules should specify a sensing period to be used and a gap period when this sensing period is used, e.g., where FBE LBT Cat-1, Cat-2, or newly defined Cat-X applies.

In some embodiments, UE1 initiates COT by transmitting during an “orphan symbol” that may be located at the beginning of the COT. The transmission during the orphan symbol can be independent, e.g., some reference or sequence DMRS signal transmission. The orphan symbol can be used with a next subsequent or adjoining transmission. For example, if there is one orphan symbol immediately followed by a six-symbol UL resource allocation, then UE transmits the UL transmission over seven symbols (including the orphan symbol), where the orphan symbol can be used to carry more data or extend the CP.

In some embodiments, multiple FBE COTs can be defined for SL UEs (e.g., UE1 and UE2). Also, the gNB can define COT initiation behavior (e.g., which UE can initiate the COT) for each COT and indicate such information via RRC, DCI, MIB, SIB, etc.

Although certain embodiments were described above in the context of FBE COT, the underlying principles are equally applicable to LBE COT, with the only differences being that LBE has more LBT categories and does not have an idle period before COT.

In some embodiments, when a UE is configured with a first COT for Uu interface transmissions (UL and DL) and a second COT for PC5 transmissions (SL), both COTs can be initiated by the same UE signaling. In other words, the first and second COTs overlap in such a way that the UE can initiate both COTs by sending the same signaling at the same time. Both COTs can be LBE, both can be FBE, or there can one LBE and one FBE. In some embodiments, the gNB can configure parameters for Uu COT and PC5 COT such as access profile, CP extension, COT priority, etc.

Within a COT, a UE can be allocated various resources for different channels, such as for PDSCH, PUSCH, SLSCH, PDCCH, PUCCH, and/or SLCCH. Different ones of these transmissions can be performed based on FBE or LBE.

In some embodiments, a UE can be allocated resources for UL transmissions based on FBE and SL transmissions based on LBE. In other embodiments, a UE can be allocated resources for UL transmissions based on LBE and for SL transmissions based on FBE. For example, the mapping between type of transmission (PUSCH/SLSCH/PUCCH/SLCCH) and mode (LBE or FBE) for a COT and can be provided by the gNB in RRC signaling, broadcast SIB, scheduling DCI for dynamic allocation, activation DCI for configured grant, group-common DCI, etc.

In some embodiments, when UE1 requests permission for initiating and/or sharing a COT, the gNB can respond according to one of the following:
positively, indicating SL UE has permission to initiate the COT;
negatively, indicating SL UE does not have permission to initiate the COT; or
ignore or refrain to respond, from which UE1 infers it does not have permission to initiate a COT.

As another option, when the gNB responds (e.g., positively or negatively), the gNB can provide different parameters such as delay for COT initiation, pause permission for COT initiation, change in COT parameters (e.g., COT offset, COT periodicity, CCA implementation, COT semi-static or dynamic type, etc.), UEs allowed to share the COT, etc.

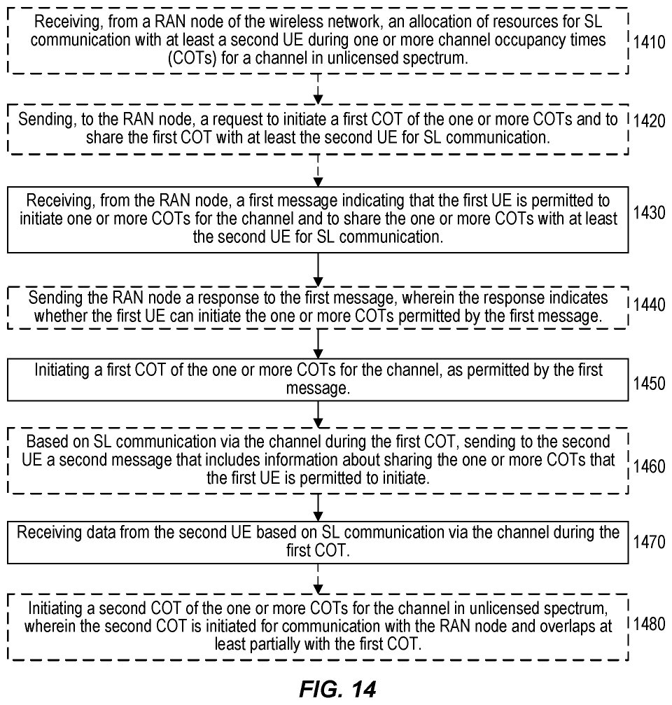

Various features of the embodiments described above correspond to various operations illustrated in FIGS. 14-16, which show exemplary methods (e.g., procedures) for a first UE, a second UE, and a RAN node, respectively. In other words, various features of the operations described below correspond to various embodiments described above. Furthermore, the exemplary methods shown in FIGS. 14-16 can be used cooperatively to provide various benefits, advantages, and/or solutions to problems described herein. Although FIGS. 14-16 show specific blocks in particular orders, the operations of the exemplary methods can be performed in different orders than shown and can be combined and/or divided into blocks having different functionality than shown. Optional blocks or operations are indicated by dashed lines.

In particular, FIG. 14 shows an exemplary method (e.g., procedure) for a first UE configured for SL communication with at least a second UE in a wireless network, according to various embodiments of the present disclosure. The exemplary method can be performed by a UE (e.g., wireless device) such as described elsewhere herein.

The exemplary method can include the operations of block 1430, where the first UE can receive, from a RAN node of the wireless network, a first message indicating that the first UE is permitted to initiate one or more COTs for a channel in unlicensed spectrum and to share the one or more COTs with at least the second UE for SL communication. The exemplary method can also include the operations of block 1450, where the first UE can initiate a first COT of the one or more COTs for the channel, as permitted by the first message. The exemplary method can also include the operations of block 1470, where the first UE can receive data from the second UE based on SL communication via the channel during the first COT, i.e., that was initiated by the first UE.

In some embodiments, the exemplary method can also include the operations of block 1410, where the first UE can receive, from the RAN node, an allocation of resources for SL communication with at least the second UE during the one or more COTs that include the first COT. In some embodiments, the exemplary method can also include the operations of block 1420, where the first UE can send, to the RAN node, a request to initiate the first COT for the channel and to share the first COT with at least the second UE for SL communication. The first message can be received (e.g., in block 1430) in response to the request.

For example, the first UE can send the request in block 1420 using a dynamic UL grant or a configured UL grant that was previously provided by the RAN node. As another example, the allocation of resources for SL communication received in block 1410 can be a dynamic SL grant or a configured SL grant.

In some embodiments, the exemplary method can also include the operations of block 1440, where the first UE can send the RAN node a response to the first message, with the response indicating whether the first UE can initiate the one or more COTs permitted by the first message.

In some embodiments, the allocation of resources is for the first COT and the request is sent (e.g., in block 1420) in response to receiving the allocation (e.g., in block 1410). In other embodiments, the allocation of resources is for the first COT and the allocation is received (e.g., in block 1410) in response to sending the request (e.g., in block 1420). In other embodiments, the allocation of resources is for a plurality of COTs including the first COT (e.g., a configured SL grant).

In various embodiments, the request (e.g., in block 1420) can include one or more of the following:
start time, end time, and/or maximum duration of the first COT;
durations within the first COT that are reserved for other UEs to transmit;
an identifier of the first UE;
a UE identifier or a group identifier associated with the second UE;
SL transmission types allowed during the first COT;
one or more services, logical channels (LCHs), logical channel groups (LCGs), or channel access priority classes allowed during the first COT;
one or more types of signaling and/or data transmissions allowed during the first COT;
one or more listen-before-talk (LBT) categories required or allowed during the first COT;
cyclic prefix (CP) configuration to be used by the second UE during the first COT; and
types of SL grants allowed during the first COT.

In various embodiments, the request can be sent according to one or more of the following:
in a radio resource control (RRC) message;
in a medium access control (MAC) control element (CE);
in a message during a random access (RA) procedure initiated by the first UE;
in a control protocol data unit (PDU) for a user-plane protocol;
via a physical uplink control channel (PUCCH); and
via a physical uplink shared channel (PUSCH).

In some of these embodiments, the request is sent using one of the following that is allocated for indicating a UE request for COT initiation and sharing: specific RA resources, specific PUCCH resources, or specific PUSCH uplink configured grant (UL CG) resources. In other of these embodiments, the request is sent as one of the following: CG uplink control information (UCI), UCI via PUCCH, or UCI via PUSCH.

In various embodiments, the first message (e.g., in block 1430) includes one or more of the following:
respective start times, end times, and/or maximum durations of the one or more COTs;
durations within the one or more COTs that are reserved for other UEs to transmit;
maximum number of UEs allowed to share the one or more COTs;
at least one identifier of a UE allowed to share the one or more COTs;
at least one group identifier associated with UEs allowed to share the one or more COTs;
SL transmission types allowed during the one or more COTs;
one or more services, LCHs, LCGs, or channel access priority classes allowed during the one or more COTs;
one or more types of signaling and/or data transmissions allowed during the one or more COTs;
one or more types of channel occupancy allowed during the one or more COTs;
whether the first UE, the RAN node, or both are allowed to initiate the one or more COTs;
and
one or more listen-before-talk (LBT) categories required or allowed during the one or more COTs;
CP configuration to be used by UEs allowed to share the one or more COTs; and
types of SL grants allowed during the one or more COTs.

In various embodiments, the first message can be received according to one or more of the following:
in system information (SI) broadcast by the RAN node;
in an RRC message;
in a MAC CE;
in a message during a RA procedure initiated by the first UE;
in a control PDU for a user-plane protocol; and
via a PDCCH or a PDSCH.

In some of these embodiments, the first message is received as downlink control information (DCI) via PDCCH and the DCI includes a bitfield that can take on a plurality of values. Each bitfield value is associated with values or settings for at least two the following:
whether dynamic channel occupancy, semi-static channel occupancy, or both are allowed during the one or more COTs;
whether the first UE, the RAN node, or both are allowed to initiate the one or more COTs; and
CP configuration to be used by UEs during the one or more COTs.

In some embodiments, the exemplary method can also include the operations of block 1460, where the first UE can, based on SL communication via the channel during the first COT, send to the second UE a second message that includes information about sharing the one or more COTs that the first UE is permitted to initiate. In such case, the data is received from the second UE (e.g., in block 1470) in accordance with the information included in the second message. In some of these embodiments, the information included in the second message comprises one or more of the following:
respective start times, end times, and/or maximum durations of the one or more COTs;
durations within the one or more COTs that are reserved for other UEs to transmit;
SL transmission types allowed during the one or more COTs;
one or more services, LCHs, LCGs, or channel access priority classes allowed during the one or more COTs;
one or more types of signaling and/or data transmissions allowed during the one or more COTs;
one or more types of channel occupancy allowed during the one or more COTs;
one or more LBT categories required or allowed during the one or more COTs;
CP configuration to be used by the second UE during the one or more COTs; and
types of SL grants allowed during the one or more COTs.

In some embodiments, the exemplary method can also include the operations of block 1450, where the first UE can send the RAN node a response to the first message, with the response indicating whether the first UE can initiate the one or more COTs permitted by the first message.

For example, the first UE can send the response before, concurrent with, or after initiating the first COT.

In some embodiments, the exemplary method can also include the operations of block 1480, where the first UE can initiate a second COT of the one or more COTs for the channel in unlicensed spectrum. The second COT is initiated for communication (i.e., UL and/or DL) with the RAN node and overlaps at least partially with the first COT.

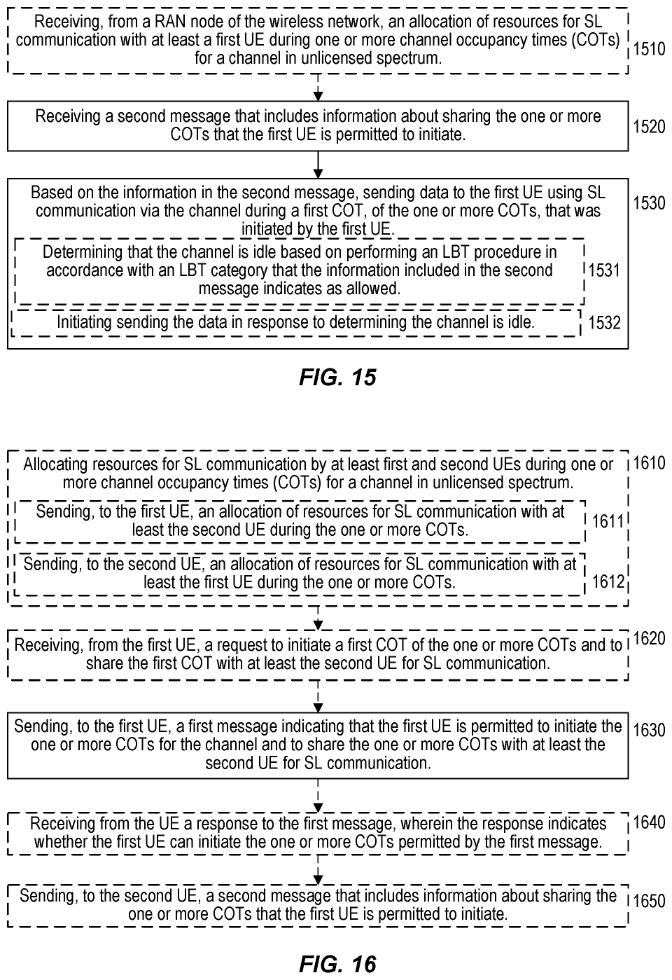

In addition, FIG. 15 shows an exemplary method (e.g., procedure) for a second UE configured for SL communication with at least a first UE in a wireless network, according to various embodiments of the present disclosure. The exemplary method can be performed by a UE (e.g., wireless device) such as described elsewhere herein.

The exemplary method can include the operations of block 1520, where the second UE can receive a second message that includes information about sharing one or more COTs that the first UE is permitted to initiate for a channel in unlicensed spectrum. The exemplary method can also include the operations of block 1530, where the second UE can, based on the information in the second message, send data to the first UE using SL communication via the channel during a first COT, of the one or more COTs, that was initiated by the first UE.

In some embodiments, the exemplary method can also include the operations of block 1510, where the second UE can receive, from a RAN node of the wireless network, an allocation of resources for SL communication with at least the first UE during the one or more COTs for the channel in unlicensed spectrum. For example, the allocation of resources for SL communication received in block 1510 can be a dynamic SL grant or a configured SL grant.

In various embodiments, the second message can be received according to one of the following:
from the first UE using SL communication via the channel in unlicensed spectrum,
from a RAN node using DL communication via the channel in unlicensed spectrum, or
from a RAN node using DL communication via licensed spectrum.

In some of these embodiments, the second message is received from the first UE during the first COT.

In various embodiments, the information included in the second message comprises one or more of the following:
respective start times, end times, and/or maximum durations of the one or more COTs;
durations within the one or more COTs that are reserved for other UEs to transmit;
SL transmission types allowed during the one or more COTs;
one or more services, LCHs, LCGs, or channel access priority classes allowed during the one or more COTs;
one or more types of signaling and/or data transmissions allowed during the one or more COTs;
one or more types of channel occupancy allowed during the one or more COTs;
one or more LBT categories required or allowed during the one or more COTs;
CP configuration to be used by the second UE during the one or more COTs; and
types of SL grants allowed during the one or more COTs.

In some embodiments, when the information included in the second message indicates that category-1 LBT is allowed, sending the data (e.g., in block 1530) is initiated within a predetermined duration after receiving the second message and without performing an LBT procedure in the channel.

Similarly, when the information included in the second message indicates that category-1 LBT is not allowed, sending the data based on the information in the second message in block 1530 includes the operations of sub-blocks 1531-1532, where the second UE determines that the channel is idle based on performing an LBT procedure in accordance with an LBT category that the information included in the second message indicates as allowed, and initiates sending the data in response to determining the channel is idle.

In addition, FIG. 16 shows an exemplary method (e.g., procedure) for a RAN node configured to facilitate SL communication between at least first and second UEs in a wireless network, according to various embodiments of the present disclosure. The exemplary method can be performed by a RAN node (e.g., base station, eNB, gNB, ng-eNB, etc., or component thereof) such as described elsewhere herein.

The exemplary method can include the operations of block 1630, where the RAN node can send, to the first UE, a first message indicating that the first UE is permitted to initiate one or more COTs for the channel and to share the one or more COTs with at least the second UE for SL communication.

In some embodiments, the exemplary method can include the operations of block 1610, where the RAN node can allocate resources for SL communication by at least the first and second UEs during the one or more COTs for the channel in unlicensed spectrum. In some of these embodiments, allocating resources for SL communication in block 1610 includes the operations of sub-block 1611, where the RAN node can send, to the first UE, an allocation of resources for SL communication with at least the second UE during the one or more COTs. In some of these embodiments, allocating resources for SL communication in block 1610 includes the operations of sub-block 1612, where the RAN node can send, to the second UE, an allocation of resources for SL communication with at least the first UE during the one or more COTs that the first UE is permitted to initiate.

In some embodiments, the exemplary method can also include the operations of block 1620, where the RAN node can receive, from the first UE, a request to initiate a first COT of the one or more COTs and to share the first COT with at least the second UE for SL communication. In such case, the first message is sent (e.g., in block 1630) in response to the request.

For example, the RAN node can receive the request in block 1630 in resources of a dynamic UL grant or a configured UL grant that was previously provided to the first UE by the RAN node. As another example, the allocation of resources for SL communication sent in sub-blocks 1611 and/or 1612 can be a dynamic SL grant or a configured SL grant.

In some embodiments, the allocation of resources is for the first COT and the request is received (e.g., in block 1620) in response to sending the allocation (e.g., in sub-block 1611). In other embodiments, the allocation of resources is for the first COT and the allocation is sent (e.g., in block 1611) in response to receiving the request (e.g., in block 1620). In other embodiments, the allocation of resources is for a plurality of COTs including the first COT (e.g., a configured SL grant).

In various embodiments, the request received in block 1620 can include any of the same contents as described above in relation to the first UE embodiments. In various embodiments, the request can be received in any of the ways that it can be sent by the first UE, as described above in relation to first UE embodiments.

In various embodiments, the first message sent in block 1630 can include any of the same contents as described above in relation to the first UE embodiments. In various embodiments, the first message can be sent in any of the ways that it can be received by the first UE, as described above in relation to first UE embodiments. In some embodiments, the exemplary method can also include the operations of block 1640, where the RAN node can receive from the first UE a response to the first message, wherein the response indicates whether the first UE can initiate the one or more COTs permitted by the first message.

In some embodiments, the exemplary method can also include the operations of block 1650, where the RAN node can send, to the second UE, a second message that includes information about sharing the one or more COTs that the first UE is permitted to initiate. In some embodiments, the second message can be sent using DL communication via the channel in unlicensed spectrum. In other embodiments, the second message can be sent via licensed spectrum. In various embodiments, the second message sent in block 1650 can include any of the same contents as described above in relation to the second UE embodiments.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

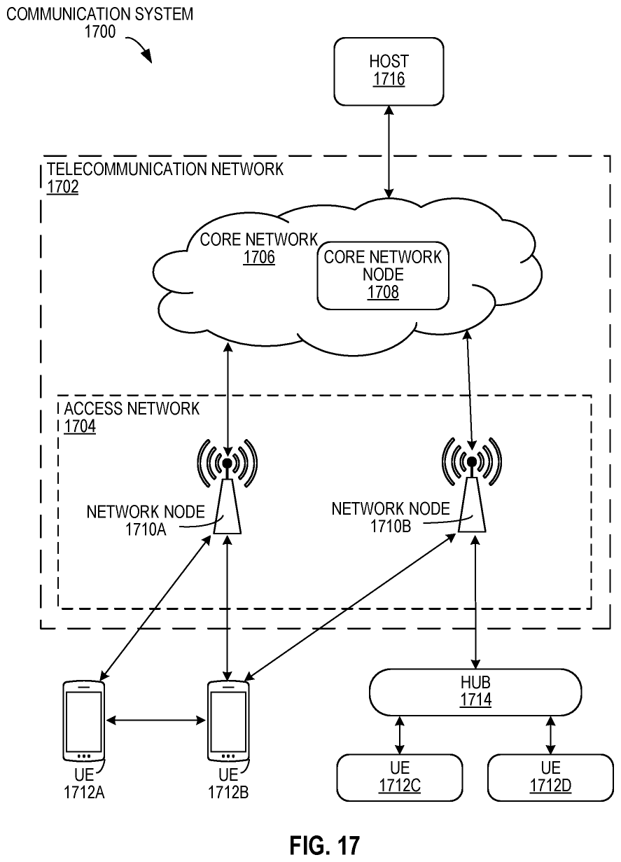

FIG. 17 shows an example of a communication system 1700 in accordance with some embodiments. In this example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3GPP access node or non-3GPP access point. The network nodes 1710 facilitate direct or indirect connection of UEs, such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

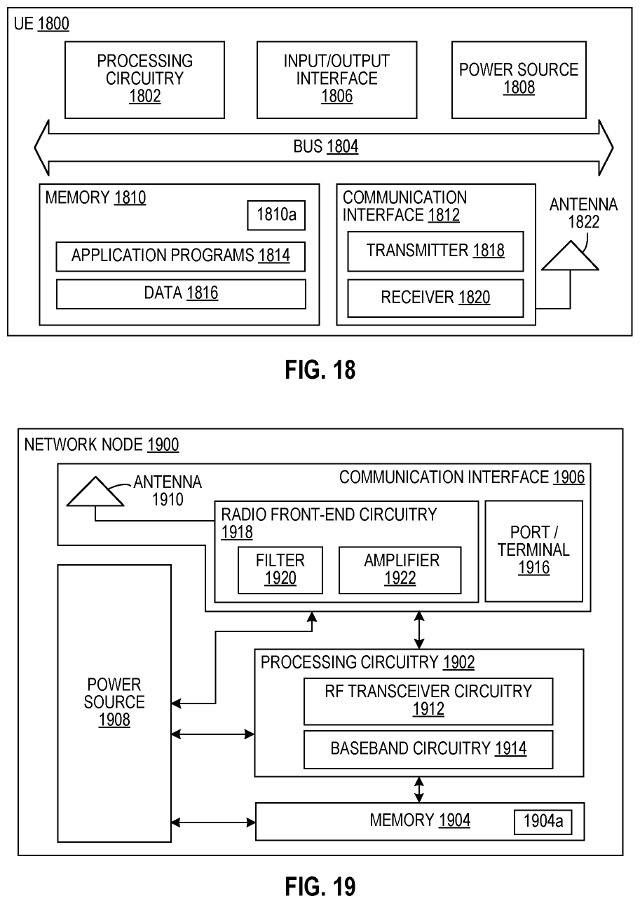

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

Additionally, memory 1810 may store any suitable instructions, data, or information, including a computer program, software, an application including one or more of logic, rules, code, tables, and/or other instructions (collectively referred to as computer program product 1810a) capable of being executed by the processing circuitry 1802, that cause UE 1800 to perform operations corresponding to various exemplary methods or procedures described herein.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As another example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As a specific example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions (collectively referred to as computer program product 1904a) capable of being executed by the processing circuitry 1902, that cause network node 1900 to perform operations corresponding to various methods or procedures described herein. Memory 1904 may be used to store any calculations made by the processing circuitry 1902 and/or any data received via the communication interface 1906. In some embodiments, processing circuitry 1902 and memory 1904 can be integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

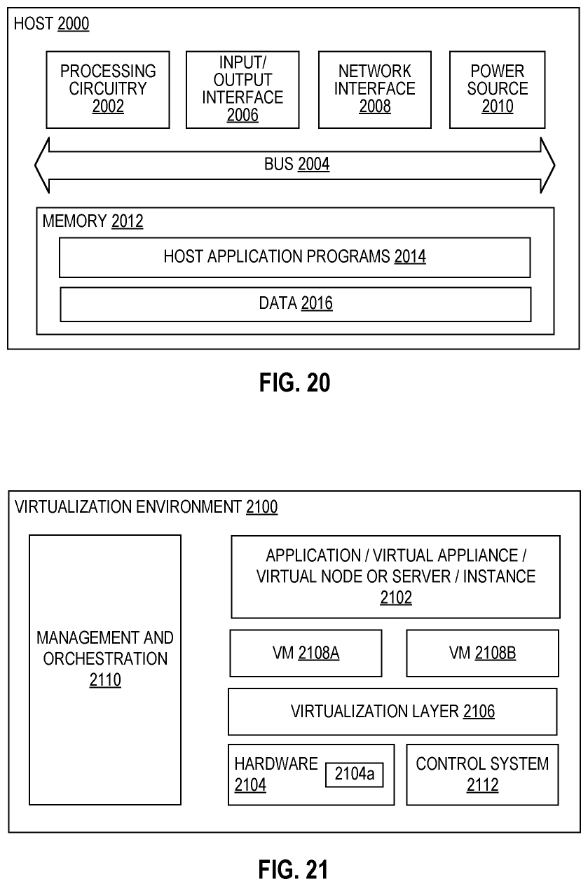

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g., such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

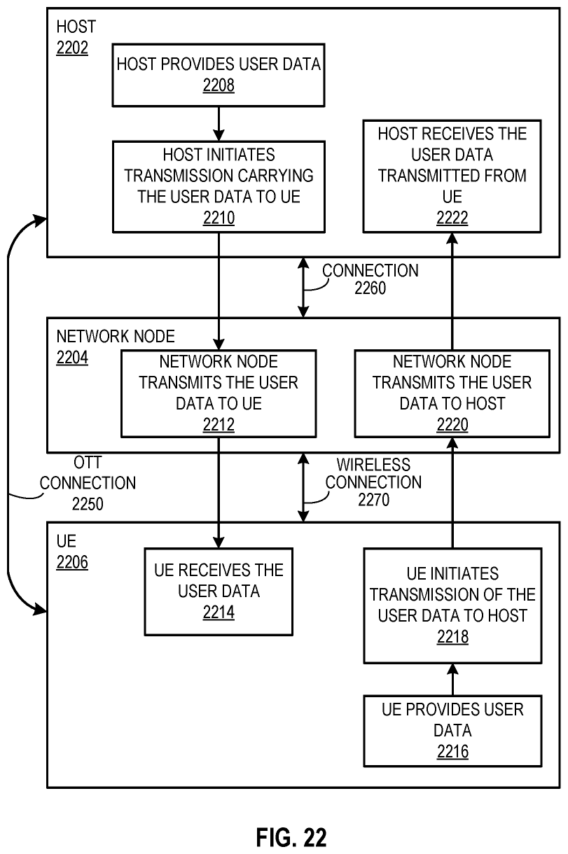

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment. More precisely, embodiments described herein provide flexible and efficient techniques for fast, agile, and/or dynamic control of SL transmissions (e.g., for Type-1 SL configured grant) that can cause interference to other SL transmissions. At a high level, embodiments improve interference management in a wireless network that supports D2D operation via SL, thereby improving performance of networks and UEs operating in unlicensed spectrum. Accordingly, OTT services can be delivered more reliably to UEs via networks operating in shared spectrum. This increases the value of such OTT services to both end users and service providers.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities. The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-45. (canceled)

46. A method for a first user equipment (UE) configured for sidelink (SL) communication with at least a second UE in a wireless network, the method comprising:
receiving, from a radio access network (RAN) node of the wireless network, an allocation of resources for SL communication with at least a second UE during one or more channel occupancy times (COTs) for a channel in unlicensed spectrum, including a first COT;
sending, to the RAN node, a request to initiate the first COT and to share the first COT with at least the second UE for SL communication;
receiving, from the RAN node in response to the request, a first message indicating that the first UE is permitted to initiate the one or more COTs and to share the one or more COTs with at least the second UE for SL communication;
initiating the first COT, as permitted by the first message, and receiving data from the second UE based on SL communication via the channel during the first COT.

47. The method of claim 46, wherein one of the following applies:
the allocation of resources is for the first COT and the allocation is received in response to sending the request; or
the allocation of resources is for a plurality of COTs including the first COT.

48. The method of claim 46, wherein the request includes one or more of the following:
start time, end time, and/or maximum duration of the first COT;
durations within the first COT that are reserved for other UEs to transmit;
an identifier of the first UE;
a UE identifier or a group identifier associated with the second UE;
SL transmission types allowed during the first COT;
one or more services, logical channels (LCHs), logical channel groups (LCGs), or channel access priority classes allowed during the first COT;
one or more types of signaling and/or data transmissions allowed during the first COT;
one or more listen-before-talk (LBT) categories required or allowed during the first COT;
cyclic prefix (CP) configuration to be used by the second UE during the first COT; and
types of SL grants allowed during the first COT.

49. The method of claim 46, wherein the first message includes one or more of the following:
respective start times, end times, and/or maximum durations of the one or more COTs;
durations within the one or more COTs that are reserved for other UEs to transmit;
maximum number of UEs allowed to share the one or more COTs;
at least one identifier of a UE allowed to share the one or more COTs;
at least one group identifier associated with UEs allowed to share the one or more COTs;
SL transmission types allowed during the one or more COTs;
one or more services, logical channels, logical channel groups, or channel access priority classes allowed during the one or more COTs;
one or more types of signaling and/or data transmissions allowed during the one or more COTs;
one or more types of channel occupancy allowed during the one or more COTs;
whether the first UE, the RAN node, or both are allowed to initiate the one or more COTs;
one or more listen-before-talk (LBT) categories required or allowed during the one or more COTs;
cyclic prefix (CP) configuration to be used by UEs allowed to share the one or more COTs; and
types of SL grants allowed during the one or more COTs.

50. The method of claim 46, wherein:
the first message is received as downlink control information (DCI) via a physical downlink control channel (PDCCH);
the DCI includes a bitfield that can take on a plurality of values; and
each value of the bitfield is associated with values or settings for at least two the following:
maximum number of UEs allowed to share the one or more COTs;
whether dynamic channel occupancy, semi-static channel occupancy, or both are allowed during the one or more COTs;
whether the first UE, the RAN node, or both are allowed to initiate the one or more COTs; and
cyclic prefix (CP) configuration to be used by UEs during the one or more COTs.

51. The method of claim 46, wherein:
the method further comprises, based on SL communication via the channel during the first COT, sending to the second UE a second message that includes information about sharing the one or more COTs that the first UE is permitted to initiate; and
the data is received from the second UE in accordance with the information included in the second message.

52. The method of claim 51, wherein the information included in the second message comprises one or more of the following:
respective start times, end times, and/or maximum durations of the one or more COTs;
durations within the one or more COTs that are reserved for other UEs to transmit;
SL transmission types allowed during the one or more COTs;
one or more services, logical channels, logical channel groups, or channel access priority classes allowed during the one or more COTs;
one or more types of signaling and/or data transmissions allowed during the one or more COTs;
one or more types of channel occupancy allowed during the one or more COTs;
one or more listen-before-talk (LBT) categories required or allowed during the one or more COTs;
cyclic prefix (CP) configuration to be used by the second UE during the one or more COTs; and
types of SL grants allowed during the one or more COTs.

53. The method of claim 46, wherein the one or more COTs include a second COT that overlaps at partially with the first COT, and the method further comprises initiating the second COT for communication with the RAN node.

54. A method for a radio access network (RAN) node configured to facilitate sidelink (SL) communication between at least first and second user equipment (UEs) in a wireless network, the method comprising:
sending, to the first UE, an allocation of resources for SL communication with at least the second UE during one or more channel occupancy times (COTs) for a channel in unlicensed spectrum, including a first COT;
receiving, from the first UE, a request to initiate the first COT and to share the first COT with at least the second UE for SL communication; and
sending, to the first UE in response to the request, a first message indicating that the first UE is permitted to initiate the one or more COTs and to share the one or more COTs with at least the second UE for SL communication.

55. The method of claim 54, wherein one of the following applies:
the allocation of resources is for the first COT and the allocation is sent in response to receiving the request; or
the allocation of resources is for a plurality of COTs including the first COT.

56. The method of claim 54, wherein the request includes one or more of the following:
start time, end time, and/or maximum duration of the first COT;
durations within the first COT that are reserved for other UEs to transmit;
an identifier of the first UE;
a UE identifier or a group identifier associated with the second UE;
SL transmission types allowed during the first COT;
one or more services, logical channels, logical channel groups, or channel access priority classes allowed during the first COT;
one or more types of signaling and/or data transmissions allowed during the first COT;
one or more listen-before-talk (LBT) categories required or allowed during the first COT;
cyclic prefix (CP) configuration to be used by the second UE during the first COT; and
types of SL grants allowed during the first COT.

57. The method of claim 54, wherein the first message includes one or more of the following:
respective start times, end times, and/or maximum durations of the one or more COTs;
durations within the one or more COTs that are reserved for other UEs to transmit;
maximum number of UEs allowed to share the one or more COTs;
at least one identifier of a UE allowed to share the one or more COTs;
at least one group identifier associated with UEs allowed to share the one or more COTs;
SL transmission types allowed during the one or more COTs;
one or more services, logical channels, logical channel groups, or channel access priority classes allowed during the one or more COTs;
one or more types of signaling and/or data transmissions allowed during the one or more COTs;
one or more types of channel occupancy allowed during the one or more COTs;
whether the first UE, the RAN node, or both are allowed to initiate the one or more COTs; and
one or more listen-before-talk (LBT) categories required or allowed during the one or more COTs;
cyclic prefix (CP) configuration to be used by UEs allowed to share the one or more COTs; and
types of SL grants allowed during the one or more COTs.

58. The method of claim 54, wherein:
the first message is sent as downlink control information (DCI) via a physical downlink control channel (PDCCH);
the DCI includes a bitfield that can take on a plurality of values; and
each bitfield value is associated with values or settings for at least two the following:
maximum number of UEs allowed to share the one or more COTs;
one or more types of channel occupancy allowed during the one or more COTs;
whether the first UE, the RAN node, or both are allowed to initiate the one or more COTs; and
cyclic prefix (CP) configuration to be used by UEs during the one or more COTs.

59. The method of claim 54, further comprising sending, to the second UE, a second message that includes information about sharing the one or more COTs that the first UE is permitted to initiate.

60. The method of claim 59, wherein the second message is sent using downlink (DL) communication via one of the following: the channel in unlicensed spectrum, or licensed spectrum.

61. A first user equipment (UE) configured for sidelink (SL) communication with at least a second UE in a wireless network, the first UE comprising:
communication interface circuitry configured to communicate with at least the second UE and with a radio access network (RAN) node of the wireless network; and
processing circuitry operatively coupled to the communication interface circuitry, wherein the processing circuitry and the communication interface circuitry are configured to:
receive, from the RAN node, an allocation of resources for SL communication with at least a second UE during one or more channel occupancy times (COTs) for a channel in unlicensed spectrum, including a first COT;
send, to the RAN node, a request to initiate the first COT and to share the first COT with at least the second UE for SL communication;
receive, from the RAN node in response to the request, a first message indicating that the first UE is permitted to initiate the one or more COTs and to share the one or more COTs with at least the second UE for SL communication;
initiate the first COT, as permitted by the first message, and receive data from the second UE based on SL communication via the channel during the first COT.

62. The first UE of claim 61, wherein one of the following applies:
the allocation of resources is for the first COT and the allocation is received in response to sending the request; or
the allocation of resources is for a plurality of COTs including the first COT.

63. The first UE of claim 61, wherein:
the first message is sent as downlink control information (DCI) via a physical downlink control channel (PDCCH);
the DCI includes a bitfield that can take on a plurality of values; and
each bitfield value is associated with values or settings for at least two the following:
maximum number of UEs allowed to share the one or more COTs;
one or more types of channel occupancy allowed during the one or more COTs;
whether the first UE, the RAN node, or both are allowed to initiate the one or more COTs; and
cyclic prefix (CP) configuration to be used by UEs during the one or more COTs.

64. A radio access network (RAN) node configured to facilitate sidelink (SL) communication between at least first and second user equipment (UEs) in a wireless network, the RAN node comprising:
communication interface circuitry configured to communicate with the first and second UEs; and
processing circuitry operatively coupled to the communication interface circuitry, wherein the processing circuitry and the communication interface circuitry are configured to:
send, to the first UE, an allocation of resources for SL communication with at least the second UE during one or more channel occupancy times (COTs) for a channel in unlicensed spectrum, including a first COT;
receive, from the first UE, a request to initiate the first COT and to share the first COT with at least the second UE for SL communication; and
send, to the first UE in response to the request, a first message indicating that the first UE is permitted to initiate the one or more COTs and to share the one or more COTs with at least the second UE for SL communication.

65. The RAN node of claim 64, wherein one of the following applies:
the allocation of resources is for the first COT and the allocation is sent in response to receiving the request; or
the allocation of resources is for a plurality of COTs including the first COT.
